(19) United States
(12) Patent Application Publication
(10) Pub. No.: US 2005/0076052 A1
(43) Pub. Date: Apr. 7, 2005

(54) Maintenance service system, method and program

(75) Inventor: Kenji Kojima, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC FIELDING, LTD.

(21) Appl. No.: 10/705,924

(22) Filed: Nov. 13, 2003

(30) Foreign Application Priority Data
Nov. 14, 2002 (JP) 2002-330614

(51) Int. Cl. G06F 17/00

(52) U.S. Cl. 707/102

(57) ABSTRACT

A multi-vendor system monitoring and reporting server is connected to a multi-vendor system. The multi-vendor system monitoring and reporting server receives and recognizes plural different trouble reporting interfaces transmitted from respective devices constituting the multi-vendor system, and automatically reports occurrence of a trouble to a system manager device, a primary maintainer terminal and each maker/vendor/maintenance company system. The primary maintainer terminal creates trouble progress information, trouble completion information, etc. and reports the trouble information from the multi-vendor system monitoring and reporting server. The primary maintainer serves as a primary maintainer to collectively perform trouble information collection, trouble dealing work and trouble management, and performs system operation, presentation of management information and discussions and adjustments of the process management among respective vendors.

### BACKGROUND OF THE INVENTION

1. Field of the Invention

The present invention relates to maintenance service system, its method and program and particularly, to maintenance service system, method and program in a multi-vendor system.

2. Description of the Related Art

According to a conventional maintenance service system, information on a trouble status of a host system is transmitted from a trouble monitoring program in the host system or a trouble monitoring device in the host system through a communication line, and the trouble status thus transmitted is monitored at a maintenance service center (see, for example, JP-A-H11-296480).

There is also known another maintenance service system in which a trouble is sensed on the basis of management information of each device connected to LAN and reported to a maintenance service center through a communication line, the trouble is subjected to diagnosis analysis at the maintenance service center and a maintenance condition and other information are achieved from the Internet, thereby performing maintenance/repair services (see, for example, JP-A-2000-196769).

The monitoring and maintenance service methods described above have been proposed mainly on the basis of the convenience of the maintenance worker side.

First, with respect to a remote trouble monitoring system disclosed in JP-A-H11-296480, when a trouble occurs in a host system 5100 itself, an input/output device 5130, a network device 5140 or a terminal 5150, OS (operating system) collects hard logs and stores them in a hard log file 5120, and also it reports occurrence of the trouble to a trouble monitoring program 5200 as shown in FIG. 19. When a trouble indicated by a hard log is associated with a device being monitored and the trouble thus indicated is critical, the trouble monitoring program 5200 merges the corresponding message in a message file 5111 with the corresponding log, and then stores the merging result into a transfer device file 5301. On the basis of a notification from the user of the host system, a personal computer 5500 at the maintenance service center accesses the transfer device file 5301, picks up the message and the hard log in the transfer device file 5301, carries out processing and edition on the information thus received and then displays the information. The maintainer at the maintenance service center carries out a maintenance work such as trouble curving, etc.

Next, with respect to a maintenance/repair service system for home electric appliances disclosed in JP-A-2000-196769, a WWW server 6101 of a maintenance/repair service center 6001 for home electric appliances accesses a home page open to a WWW Internet network 6003 and registers necessary items to make a maintenance contract. If the maintenance contract is established, a contractor is registered in a customer data base 6103 of the maintenance/repair service center 6001. A self trouble diagnosing means installed in a home electric appliance (a television set 6203, an air conditioner 6204, . . . , an illuminator 6205) monitors the operation status of each part of the home electric appliance and transmits a report to an equipment information managing device 6201 if any trouble occurs in a part. Upon receiving this report, the equipment information managing device 6201 automatically calls a maintenance/repair service center 6001 through a telephone network 6004, and reports trouble information to a trouble diagnosis device 6102 of the maintenance/repair service center 6001. In the maintenance/repair service center 6001, when receiving the trouble information, the trouble diagnosis device 6102 searches a trouble diagnosis data base 6104 to determine information on the cause for the trouble, a repair content needed for the trouble, exchange parts, etc.

Furthermore, there has been recently popular a multi-vendor information processing system which is constructed as an open system by plural makers' equipment (appliances).

In such a multi-vendor system, a large number of various information processing devices and troubles of appliances are concentrated to a single automatic reporting device, and a report is transmitted from the automatic reporting device to a maintenance service center system (see, for example, JP-A-2001-356929).

However, the above-described prior art has the following problems.

A first problem is as follows. In the recent information processing system, each processing device itself exhibits sufficient trouble sensing and processing functions by its service processor, and thus the system effectively functions to perform a trouble dealing work for each specific maker's specific type of information processing device independently. However, under the recent condition that a system is constructed in a multi-vendor style using network connection which is based on a server-client construction, it has been already neither an effective function nor an effective method for coping with troubles as the whole system to handle trouble information independently by each information processing device of various types of vendors.

The reason for this is as follows. That is, when a specific single device has a trouble in an information processing device system which is constructed in the server-client construction and in the multi-vendor style, the manager of the system is required to immediately grasp damages and effects on the overall system when the specific device is stopped due to the trouble, and also immediately communicate with many end users and announce instructions to the end users.

A second problem is as follows. The conventional maintenance service system and method are mainly based on the convenience of only the maintenance service center and the maintenance service workers, that is, the system and method focus on transmission of trouble information to the maintenance service center. Therefore, no abnormality information is automatically transmitted to a system user side, and a telephone communication or the like is merely made from the maintenance service center to the system user side.

The reason for this is as follows. Since an abnormality status is transmitted from the maintenance service center to the system manager of the system user side by telephone or the like, the information is transmitted to the system manager with time delay. Furthermore, if the system manager of the system user side is absent when an inquiry on the system condition is made from the maintenance service center to the system manager of the system user side by telephone, there would occur such a situation that the maintenance service center cannot grasp the system condition, and also the maintenance worker would start to take a countermeasure to the trouble with time delay. Still furthermore, the system manager at the system user side is swamped with dealing with end users, and thus the maintenance service center cannot achieve trouble information from the system manager. Therefore, it is delayed for the maintenance worker to make an initial instruction and take a countermeasure to the trouble, and it takes much time to grasp the trouble condition.

This problem appears remarkably particularly in a case where there is no person at setup places of an important server, an equipment monitoring device, etc. because unattended operation based on an automatic operation device of an information processing device is promoted, so that abnormality is first recognized on the basis of an indication from an end user or a report from the maintenance service center.

A third problem is as follows. The conventional maintenance system and method are mainly based on the information processing device, and operated only in the monitoring from the maintenance service center and taking countermeasure. Therefore, they are insufficient to equipment other than the information processing device.

The reason for this is as follows. That is, monitoring and maintenance services for abnormality states of environmental facilities in which information processing devices are set up, for example, failure of an air conditioner, abnormality in upper limit/lower limit temperature, abnormality in upper limit/lower limit humidity, water leakage, etc. and abnormality states of incidental facilities of the information processing devices, for example, failure of an uninterruptible power supply source, electric leakage detection/breaking of a distribution board breaker, etc. are performed in such a style that the maintenance service center cannot deal with the abnormality states from the place where the maintenance service center is located, that is, these abnormality states are alarmed by using a display board of a room where information equipment is set up or by using an abnormality display lamp and a buzzer of a remote display board in an operation management department, or in such a style that even when the maintenance service center can deal with the abnormality states from the place where it is located, it cannot collectively deal with the abnormality states of the environmental facilities and the incidental facilities when viewed from the overall system side, but it individually deals with each of the abnormality states only as independent monitoring and maintenance service for the environmental facilities and incidental facilities.

A fourth problem is as follows. In the conventional maintenance service system and method, the users of the information processing device and the system manager in the system which is built up in the server-client construction and in the multi-vendor style can select and construct the optimal hardware and software as facilities in the information processing system in consideration of cost-performance. However, with respect to the operation and maintenance of the system and the management of troubles, a system user must carry out complicated dealing works to plural different vendors/makers.

The reason for this is as follows. That is, when abnormality in network communication occurs between information processing devices produced by plural different vendors/makers, the system manager must do a troublesome task of transmitting abnormality information and reporting the abnormality condition to plural maintenance service sources.

Furthermore, since the information processing system constructed by the devices of plural vendors/makers is used, each of management items concerning all the operation, maintenance and troubles must be discussed among the plural vendors, makes.

For example, it is assumed that an information processing device is newly added in a network, but it does not operate. In this case, an adjustment work among plural vendors/makers is needed even when hardware under trouble is addressed to the same device, for example, it is needed to do an adjustment work of requesting plural vendors/makers of routers of the network to check the system although the information processing device side or the network device side serving as a partner reports the above status.

When a meeting for trouble management and specifications thereof with respect to maintenance, operation and troubles is periodically held to have discussions and considerations, in some cases it may be difficult for all the plural vendors/makers to meet in conference because of their speculation and competing items, and particularly they frequently express disapproval to the proceedings for the trouble maintenance. Accordingly, the meeting must be repetitively held at the frequency corresponding to the number of the vendors/makers, and it is required to adjust the opinions between some vendor/maker and another vendor/maker. If it is required for some discussion contents, a meeting must be held again.

The foregoing point will be described in more detail with reference to FIG. 21. FIG. 21 is a block diagram showing the corresponding relationship between a system manager and each of parties which are interested in a conventional information processing system having a multi-vendor construction.

In FIG. 21, when each of server equipment and incidental equipment is viewed from a system manager 301 in an information processing system constructed by multi-vendor devices, plural cumbersome dealings represented by linking the respective blocks to one another through association lines are needed as the dealing relationship among the blocks.

That is, each of makers/vendors A 312 to D 315 deal with the operating servers A320 to D 323 respectively, a maker/vendor B 312 deals with a final server 324, and a maker/vendor A 312 deals with network facilities 325.

The respective makers/vendors are laterally linked to respective maintenance companies A 316 to D 319 in one-to-one correspondence, however, the maintenance companies, the operating servers A 320 to D 323, the final server 324 and the network facilities 325 are not directly laterally linked to one another in one-to-one correspondence.

Particularly, incidental facilities located at places where information processing system facilities are set up, such as an air conditioner 326, power equipment 327, a monitoring board 328, a monitoring device, etc., are subjected to self-maintenance by a department called as an equipment division of a management department A306, or managed and operated by dealings of the maintenance companies A 316 to D 319 respectively. Therefore, they are frequently separated from the maintenance of the information processing system facilities, and arranged in a vertically divided construction every maintenance company.

Accordingly, the system manager 301 must individually and separately carry out dealing/instruction/meeting/report A 308 to D 311 with each of the makers/vendors A 312 to D 315, and thus the system manager 301 is kept under such a condition that he/she must carry out inefficient disposal of business affairs with much labor. In addition, the system manager 301 is also kept under the same condition in connection with end users A 302 to D 305 and management departs A 306 to B 307.

A fifth problem is as follows in the conventional maintenance service system and method, maintenance service targets are discriminated from one another on a maker/vendor basis, and a case where the maintenance work is inefficient occurs in a large-scale system.

The reason for this is as follows. There frequently occurs a case where the same or similar operating system is used, and thus it has been possible to collect error logs, etc. by using an engineer's skill of one vendor/maker. Therefore, when abnormality occurs, a primary dealer could temporarily avoid the abnormality and collect error logs without being relied on the system manager or the engineer of the vendor/maker of the abnormal device if the primary dealer has normal skill and experience. That is, on the basis of a maintenance service of a specific one vendor/maker, that is, only one engineer, the primary deader can grasp the maintenance condition of the overall system at a deeper technical level than the system manager, that is, at a technical level nearer to the level of the vendor/maker of the abnormal device, and thus plural trouble windows can be unified into one window, thereby enhancing the maintenance efficiency.

Furthermore, a vendor/maker handling the most important servers such as a file server and a network server in the system necessarily has the initiative to operate and stop the overall system, and thus it has collective charge of the management and instruction in the working process for periodical check of hardware, software maintenance, so that the efficiency of the maintenance service of the system can be more enhanced, and labor imposed on the system user can be omitted.

### SUMMARY OF THE INVENTION

The present invention has been implemented in view of the foregoing situation, and a first object of the present invention is to provide a system that can immediately grasp the damage imposed on the overall system in place of independent dealing, trouble sensing and reporting by a service processor in each individual system device, and thus reduce the load of a trouble dealing work to be imposed on a system manager and a maintainer in an information processing system having a server-client construction based on network connection in a multi-vendor system.

A second object of the present invention is to enable a system manager to collectively monitor the overall system and further enable a trouble report between the system manager and end users, thereby overcoming the problem of the conventional information system in which the trouble sensing and reporting method mainly focuses on the convenience of a maintenance service center and a maintenance service worker, a worker in the maintenance service center transmits and checks the trouble to the system manager and the user by telephone or the like, and a trouble dealer at the trouble-occurring place is swamped with telephone dealing from the maintenance service center and dealing with the endusers, so that an initial action to repair the trouble is delayed.

A third object of the present invention is to provide the system with trouble monitoring and reporting functions for environmental facilities and incidental facilities at the setup places of information processing devices and also trouble monitoring and reporting functions for network facilities to thereby make the function of the system complete, and also provide the system with a function of collectively managing, as the overall system, all the trouble monitoring and reporting functions which independently and individually operate in each device, by automatically transmitting necessary information to related departments and maintenance/repair companies.

A fourth object of the present invention is to provide a method in which a vendor/maker shouldering the responsibility for a server having an important function on the system management in the overall system can perform collective management on the overall system as a main body in order to avoid such a situation that the system manager must deal with each of vendors/makers individually because of the multi-vendor structure, thereby enhancing the convenience between the system manager and the users and the efficiency of the maintenance service.

A fifth object of the present invention is to provide a method in which some vendor/maker can have charge of collectively performing the system maintenance for the overall system because the operating systems in multi-vendor based large-scale systems have been designed to have the same construction, so that a system engineer of some specific vendor/maker can temporarily deal with software maintenance and collection of error messages and error logs for hardware at the initial stage when a system trouble occurs, thereby enhancing the efficiency of the maintenance service.

In order to attain the above objects, according to a first aspect of the present invention, there is provided a maintenance service system for carrying out maintenance service on a multi-vendor system, comprising: a multi-vendor system which is constructed by various types of equipments supplied from plural vendors and carries out information processing; a multi-vendor system monitoring and reporting server which is connected to the multi-vendor system, detects a trouble in the multi-vendor system and reports trouble information; a primary maintainer terminal which is managed and operated by a primary maintainer, receives the trouble information reported from the multi-vendor system monitoring and reporting server, instructs a trouble solving dealing to a maintenance company system associated with the trouble, and creates and transmits a report document relating to a trouble occurrence condition and a trouble solving condition; and the maintenance company system for receiving the trouble information reported from the multi-vendor system monitoring and reporting server to do maintenance of equipments constituting the multi-vendor system.

According to a maintenance service system of a second aspect of the present invention, in the maintenance service system of the first aspect, the multi-vendor system monitoring and reporting server comprises an interface conversion device for receiving a trouble automatic reporting message or automatic reporting signal output from each of the various types of equipments and converting the message or signal thus received to a trouble message, an RS signal sensing portion for sensing an RS transmission request signal and transmitting the signal to the interface conversion device, a trouble automatic reporting device for reporting the trouble message, and a trouble mail server.

According to a maintenance service system of a third aspect of the present invention, in the maintenance service system of the second aspect, the various types of equipments comprise server equipment, client equipment and incidental equipment.

According to a maintenance service system of a fourth aspect of the present invention, in the maintenance service system of the third aspect, server equipment has a SVP (service processor) , and the SVP has means for detecting a trouble and notifying the trouble to the interface conversion device and the maintenance company system through a modem.

According to a maintenance service system of a fifth aspect of the present invention, in the maintenance service system of the third aspect, the server equipment has a SVP (service processor) and designed so that a DTE cable serving as the interface cable between the SVP and a modem is connected between the SVP and the modem while relayed at the RS signal sensing portion, the SVP has means for detecting a trouble and notifying the trouble to the maintenance company system through the modem, and the interface conversion device senses through the RS signal sensing portion an RS transmission request signal out of a DTE interface signal to the modem which is transmitted out to the DTE cable, thereby recognizing occurrence of the trouble.

According to a maintenance service system of a sixth aspect of the present invention, in the maintenance service system of the third embodiment, the server equipment has means for detecting a trouble through an operating system and notifying the trouble through a modem to the interface conversion device and the maintenance company system.

According to a maintenance service system according to a seventh aspect of the present invention, in the maintenance service system of the third aspect, the server equipment is designed so that a DTE cable serving as an interface cable between a SVP (service processor) and a modem is connected between the SVP and the modem while relayed through the RS signal sensing portion, the server equipment has means for detecting a trouble and notifying the trouble through the modem to the maintenance company system, and the interface conversion device senses through the RS signal sensing portion an RS transmission request signal out of a DTE interface signal to the modem which is transmitted out to the DTE cable, thereby recognizing occurrence of the trouble.

According to a maintenance service system of an eighth aspect of the present invention, in the maintenance service system, the server equipment has means for detecting a trouble and notifying a message to the interface conversion device with an RS232C serial interface signal.

According to a maintenance service system of a ninth aspect of the present invention, the incidental equipment of the third aspect has means for notifying a message to the interface conversion device on the basis of an RS232C serial interface signal when a trouble is detected.

According to a maintenance service system of a tenth aspect of the present invention, the incidental equipment of the third aspect has means for notifying the interface conversion device on the basis of a contact point signal with which a contact point is closed at a trouble occurrence time and opened at a normal time.

According to a maintenance service system of an eleventh aspect of the present invention, in the maintenance service system of the fifth, seventh, eight, ninth or tenth aspect, the interface conversion device has means for sensing the signal and carrying out trouble message conversion/addition corresponding to the signal.

According to a maintenance service system of a twelfth aspect of the present invention, the maintenance service system of the first aspect further comprises a system manager device containing a system console, an operation monitoring server and a mail server to manage the multi-vendor system at a system manager.

According to a maintenance service system of a thirteenth aspect of the present invention, in the maintenance service system of the twelfth aspect, the system console and the operation monitoring server have means for detecting a message containing a trouble term from messages received by the system console and the operation monitoring server and transmitting the message thus detected to the primary maintainer terminal.

According to a fourteenth aspect of the present invention, there is provided a maintenance service method for carrying out maintenance service for a multi-vendor system which is constructed by various types of equipments supplied from plural vendors and carries out information processing, the method comprising the steps of: at a multi-vendor system monitoring and reporting server, monitoring the multi-vendor system to detect a trouble, and reporting trouble information to a primary maintainer terminal and a maintenance company system; at the primary maintainer terminal, receiving the trouble information reported from the multi-vendor system monitoring and reporting server, carrying out trouble analysis and trouble dealing, instructs a trouble solving dealing to a maintenance company system associated with the trouble, creating a report document on trouble occurrence condition and transmitting the report document to a system manager device, an end user client and a maintenance company system; at the maintenance company system, receiving the trouble information reported from the multi-vendor system monitoring and reporting server, receiving the instruction of the trouble solving dealing from the primary maintainer terminal, carrying out maintenance of equipments under trouble which constitutes the multi-vendor system, and reporting a trouble dealing condition to the primary maintainer terminal; and at the primary maintainer terminal, creating a report document on the trouble solving condition and transmitting the report document to the system manager device, the end user client and the maintenance company.

According to a maintenance service method of a fifteenth aspect of the present invention, in the maintenance service method of the fourteenth aspect further comprises the steps of, at a primary maintainer operating the primary maintainer, creating operation stop information for periodic checkup, current status information of each equipment, system operation relating information, report information relating to system management and process information for check and maintenance/repair work by using the primary maintainer terminal, and transmitting an electronic mail having the information thus created via the multi-vendor system monitoring and reporting server or presents (displays, etc.) the information thus created on the Web of the multi-vendor system monitoring and reporting server.

According to a maintenance service method of a sixteenth aspect of the present invention, in the maintenance service method of the fourteenth aspect further comprises the steps of, at a primary maintainer, starting and executing a test run job by using the primary maintainer terminal after the trouble dealing step is completed, checking whether the trouble is finished, and restarting a business operation.

According to a maintenance service method of a seventeenth aspect of the present invention, in the maintenance service method of the fourteenth aspect, the overall trouble dealing step is carried out by the primary maintainer.

According to a maintenance service method of an eighteenth aspect of the present invention, in the maintenance service method of the fourteenth aspect, the trouble dealing step is carried out with initiative by the primary maintainer grasping the whole of the multi-vendor system while the burden of the trouble dealing step is shared to the primary maintainer and secondary and subsequent maintainers.

According to a maintenance service method of a nineteenth aspect of the present invention, in the maintenance service method of the fourteenth aspect, the trouble dealing step contains a window dealing step at which the primary maintainer carries out a window dealing work to the system manager and the end user, wherein the primary maintainer delivers the trouble dealing work to the secondary and subsequent maintainers and the trouble dealing work thus delivered is carried out by the secondary and subsequent maintainers.

According to a maintenance service method of a twentieth aspect of the present invention, the trouble dealing step of the maintenance service method of the seventeenth aspect comprises the steps of: at the primary maintainer, carrying out a restart-up operation when it is judged on the basis of a business content of a system server equipment under trouble and a trouble content that the system operation should be preferentially continued; regarding the trouble occurrence as an intermittent trouble and continuing the system operation when the restart-up operation succeeds and thus the system operation is continued; securing a machine time for investigation of causes for the trouble and research and countermeasure to trouble/failure; stopping the operation when an operation stopping condition is satisfied; regarding the trouble as not the intermittent trouble, but a fixed trouble and carrying out an operation stopping operation for carrying out a trouble dealing work; stopping the system server equipment to preferentially investigate causes for the trouble occurrence and deal with the trouble when it is judged that it is not preferential to continue the system operation; collecting trouble error logs; analyzing the error logs by an engineer of an assigned technical support department or the primary maintainer itself; ordering a trouble part when a trouble site is found out through the error log analysis; settling a part estimated as a cause of the trouble on the basis of the trouble content and the error logs when no trouble site is found out, and ordering the part thus settled; receiving a part delivered; exchanging the trouble part or trouble-estimated part by the part thus delivered; and reporting a trouble-dealing information on the trouble dealing condition and the prospect of recovery to the system manager and the end user.

According to a maintenance service method of a twenty first aspect of the present invention, the trouble dealing step of the maintenance service method of the eighteenth aspect comprises the steps of: at the primary maintainer, carrying out a restart-up operation, an operation stopping operation, an operation of stopping securing investigation machine time and an error-log collecting operation, the operations being relevant to the operation of system server equipment; at the secondary and subsequent maintainers, analyzing the error logs, specifying a trouble part, ordering a new part, carrying the new part, exchanging the trouble part by the new part, and reporting a trouble dealing condition to the primary maintainer; and at the primary maintainer, receiving a progress report from the secondary and subsequent maintainers, and reporting trouble dealing information on the trouble dealing condition and the prospect of recovery to the system manager and the end user together with a primary-maintainer's estimate of the situation.

According to a maintenance service method according to a twenty second aspect of the present invention, the trouble dealing step of the nineteenth aspect comprises the steps of: at the secondary and subsequent maintainers, re-starting up, stopping the operation, collecting error logs, analyzing the error logs, specifying a trouble part, ordering the part, carrying the part, exchanging the part and reporting the trouble dealing condition to the primary maintainer; and at the primary maintainer, receiving a progress repot from the secondary and subsequent maintainers, and reporting trouble dealing information on the trouble dealing condition and the prospect of recovery to the system manager and the end user together with a primary-maintainer's estimate of the situation.

According to a maintenance service method of a twenty third aspect of the present invention, in the twentieth, twenty first and twenty second aspects of the present invention, the step of carrying out trouble dealing further comprises the steps of with respect to software trouble, collecting trouble dump data, analyzing the dump data, requesting creation of a patch correction object for the software trouble, achieving the patch correction object thus requested, and applying the patch correction object thus achieved.

According to a twenty fourth aspect of the present invention, there is provided a maintenance service program for enabling a computer to execute maintenance service for a multi-vendor system which is constructed by various types of equipments supplied from plural vendors and carries out information processing, the method comprising the steps of: at a multi-vendor system monitoring and reporting server, monitoring the multi-vendor system to detect a trouble, and reporting trouble information to a primary maintainer terminal and a maintenance company system; at the primary maintainer terminal, receiving the trouble information reported from the multi-vendor system monitoring and reporting server, carrying out a trouble dealing work, instructing a trouble solving work to a maintenance company system associated with the trouble, and creating a report document on a trouble occurrence condition and a trouble solving condition and transmitting the report document to a system manager device, an end user client and the maintenance company system; and at the maintenance company system, receiving the trouble information reported from the multi-vendor system monitoring and reporting server, receiving an instruction of the trouble solving work from the primary maintainer terminal, carrying out maintenance for trouble equipment constituting the multi-vendor system and a function of reporting a trouble dealing condition to the primary maintainer terminal.

According to a maintenance service program according to a twenty fifth aspect of the present invention, in the program of the twenty fourth aspect, the method further comprises the steps of: at the primary maintainer terminal, creating operation stop information for periodic checkup, current status information of each equipment, system operation relating information, report information relating to system management and process information of maintenance/repair work; transmitting the information thus created through the multi-vendor system monitoring and reporting server with an electronic mail; and presenting the information thus created on the Web of the multi-vendor system monitoring and reporting server.

### BRIEF DESCRIPTION OF THE DRAWINGS

In the accompanying drawings:

FIG. 1 is a diagram showing the technical concept of a maintenance service system according to the present invention;

FIG. 2 is a diagram showing an example of a multi-vendor system;

FIG. 3 shows the relationship among a system user side, a system equipment supply side and a primary maintainer;

FIG. 4 is a diagram showing a method of handling a complicatedly associated multi-vendor system like a single vendor system;

FIG. 5 is a block diagram showing the detailed construction of an embodiment of the present invention;

FIG. 6 is a diagram showing an operation flow when a trouble is monitored and reported;

FIG. 7 is a diagram showing an operation flow when a trouble is monitored and reported;

FIG. 8 is a diagram showing an operation flow when a trouble condition is transmitted;

FIG. 9 is a diagram showing the overall flow of the dealing operation of trouble maintenance;

FIG. 10 is a diagram showing an operation flow of a first method of a trouble dealing work;

FIG. 11 is a diagram showing an operation flow of a second method of the trouble dealing work;

FIG. 12 is a diagram showing an operation flow of a third method of the trouble leading work;

FIGS. 13A to 13E are diagrams showing an example of a method of transmitting trouble information;

FIGS. 14A to 14D are diagrams showing an example of a distributed message by an electronic mail;

FIG. 15 is a diagram showing a report content window display relating to system operation;

FIG. 16 is a diagram showing a report content window display relating to system management;

FIG. 17 is a diagram showing an example of a periodic checkup and work schedule table;

FIG. 18 is a diagram showing an example of an information content relating to the system which is presented on Web;

FIG. 19 is a block diagram showing the construction of a conventional remote trouble monitoring system;

FIG. 20 is a block diagram showing the construction of a conventional maintenance service system for electric home appliances; and

FIG. 21 is a block diagram showing the corresponding relationship between a system manager and each of parties associated with an information processing system based on a multi-vendor construction.

### DETAILED DESCRIPTION OF THE PREFERRED EMBODIMENTS

Preferred embodiments according to the present invention will be described hereunder with reference to the accompanying drawings.

First, the concepts of a maintenance service system and a maintenance service method according to the present invention will be described with reference to the accompanying drawings.

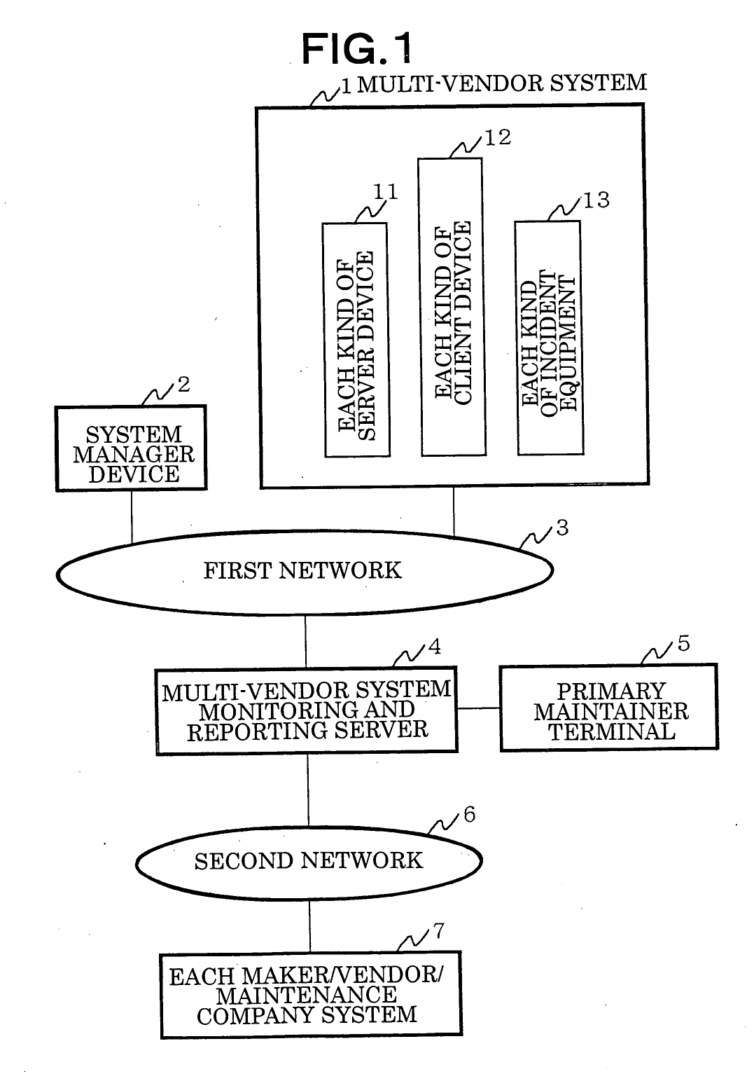

First, the concept of the maintenance service system according to the present invention will be described with reference to FIG. 1. FIG. 1 is a diagram showing the concept of the maintenance service system according to the present invention.

Referring to FIG. 1, the maintenance service system according to the present invention is equipped with a multi-vendor system 1, a system manager device 2, a first network 3, a multi-vendor system monitoring and reporting server 4, a primary maintainer terminal 5, a second network 6, each maker/vendor/maintenance company system 7.

The multi-vendor system 1 contains various types of server devices 11, various types of client devices 12 and various types of incidental facilities 13 (an air conditioner, a uninterruptible power supply source, a monitoring device, etc.) and carries out information processing. These devices constituting the multi-vendor system are supplied from plural vendors. The various typed of client devices 12 are devices used by end users, and they are connected to the various types of server devices 11 through a network such as LAN (Local Area Network) or the like.

The system manager device 2 is used to manage the multi-vendor system 1 by a system manager, and it contains a system console, an operation monitoring server, a mail server, etc.

The first network 3 is a communication network such as LAN or the like through which the multi-vendor system 1, the system manager device 2 and the multi-vendor system monitoring and reporting server 4 are connected to one another.

The multi-vendor system monitoring and reporting server 4 is connected to the multi-vendor system 1 to detect a trouble of the multi-vendor system 1, and reports trouble information to the primary maintainer terminal 5, the system manager device 2 and each maker/vendor/maintenance company system 7. The multi-vendor system monitoring and reporting server 4 is managed and operated by a primary maintainer.

The primary maintainer terminal 5 is a terminal for the primary maintainer, and connected to the multi-vendor system monitoring and reporting server 4 through the network such as LAN or the like. The primary maintainer terminal 5 has a function of receiving trouble information reported from the multi-vendor system monitoring and reporting server 4, a function of instructing trouble solution and progress reports to each maker/vendor/maintenance company system 7 related to the trouble by telephone or the like, a function of creating a document for reporting a trouble occurrence condition, a trouble solving condition, etc., and transmitting the document to parties concerned by using the mail function of the multi-vendor system monitoring and reporting server 4, a function of creating a Web content of system operation management information such as an operation past record, periodic maintenance information, etc. and registering the Web content thus created into the Web function of the multi-vendor system monitoring and reporting server 4 so that the Web content can be viewed by using a Web browser.

The primary maintainer is a party interested who serves as a maintenance dealing window to discipline the respective makers/vendors/maintenance companies associated with the multi-vendor system and collectively perform the maintenance for the system. For example, when various equipment constituting the multi-vendor system are supplied from a vendor A, a vendor B, a vendor C and a vendor D, a vendor serving as a maintenance dealing window is selected and settled as a primary maintainer (for example, vendor A), and the other vendors B, C and D are set as secondary and subsequent maintainers. The primary maintainer is settled through a meeting among the system manager and the respective vendors, however, a vendor which supplies important equipment is normally selected as the primary maintainer.

The second network 6 is a communication network through which the multi-vendor system monitoring and reporting server 4 and each maker/vendor/maintenance company system 7 are connected to each other, and for example it comprises LAN, a public circuit, an ISDN circuit, the Internet or the like.

Each maker/vendor/maintenance company system 7 means the system of the respective makers/vendors/maintenance companies having charge of maintenance services of the facilities constituting the multi-vendor system 1. Each maker/vendor/maintenance company system 7 has a function of receiving the trouble information reported from the multi-vendor system monitoring and reporting server 4. Upon receiving an instruction of trouble solution and progress report from the primary maintainer terminal 5, each maker/vendor/maintenance company system 7 carries out the trouble solving work and transmits the progress report and the solution report to the primary maintainer terminal 5.

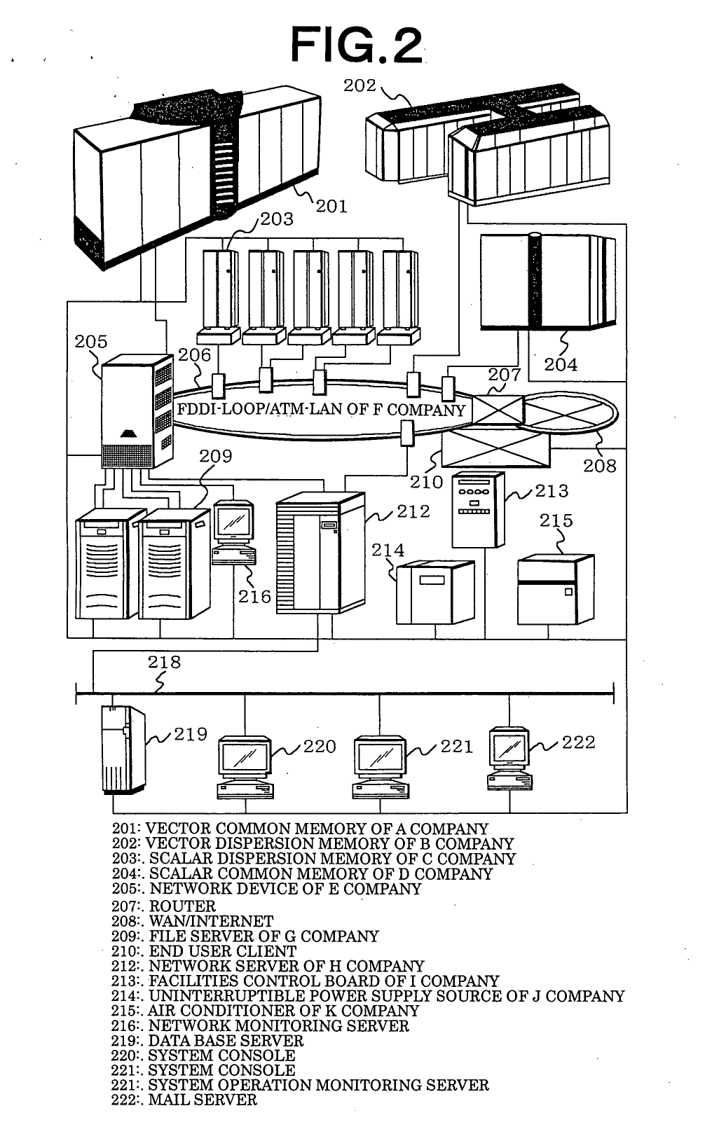

FIG. 2 shows an example of the multi-vendor system, and particularly FIG. 2 shows an example of a super computer system constructed by multi-vendor system devices. Super computers as operating server devices have different favorite operation performance in accordance with the difference in architecture among the respective makers, and thus the system constructed by the operating server devices is designed in a multi-vendor construction.

Referring to FIG. 2, a vector common memory machine 201 produced by A company, a vector dispersion memory machine 202c produced by B company, a scalar dispersion memory machine 203 produced by C company and a scalar common memory machine 204 produced by D company are connected to FDDI-LOOP/ATM-LAN 206 produced by F company through a network device 205 produced by E. An end user client 210 is connected to each server through DDI-LOOP/ATM-LAN 218. An end user client 210 at a remote place is connected to a WAN/Internet 208 through a router 207.

A network monitoring server 216 as a system manager device with which the system manager manages the multi-vendor system is connected to a system console 220 of each server, an operation monitoring server 221 for carrying out operation execution state, charging, user registration, etc., a mail server 222 for communications on business for the system user, the maintenance information communication, dealing with interrogation, dealing with inquiries, etc. through ETHER-LAN 218.

Subsequently, the concept of the maintenance service method according to the present invention will be described with reference to FIG. 1.

According to the maintenance service method of the present invention, the primary maintenance collectively shoulders the responsibility for all the maintenance services on the multi-vendor system 1 from the system manager. The primary maintainer shoulders the responsibility between the user side of the multi-vendor system 1 (system manager, end users) and equipment supplier side of the multi-vendor system 1 (makers/vendors/maintenance companies), and collectively carries out the trouble dealing work, etc. of the multi-vendor system (reporting/dealing/supporting, etc.).

That is, the primary maintainer monitors the trouble of the multi-vendor system 1 by using the multi-vendor system monitoring and reporting server 4 and the primary maintainer terminal 5, collectively manages information of occurring trouble, carrying out the trouble solving work by itself or in cooperation with the secondary and subsequent maintainers (i.e., while the burden of the trouble solving work is shared to the primary maintainer and the secondary and subsequent maintainers) and properly reports the status to the parties interested such as the system manager, etc. Furthermore, the primary maintainer creates system operation management information such as operation past record, periodic maintenance information, etc. and notifies the information to the parties interested (the system manager, the end user, the maker/vendor/maintenance company). Furthermore, the primary maintainer makes an adjustment between the user side such as the system manager, etc. and the system equipment supplier side (for example, an adjustment on a meeting schedule, etc.).

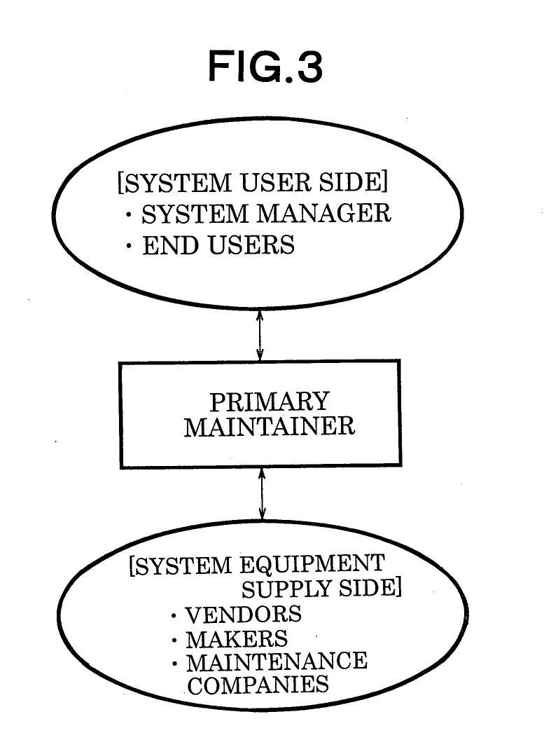

FIG. 3 shows the relationship among the system user side, the system equipment supplier side and the primary maintainer. Referring to FIG. 3, it is shown that the primary maintainer is located so as to mediate between the system user side and the system equipment supplier side.

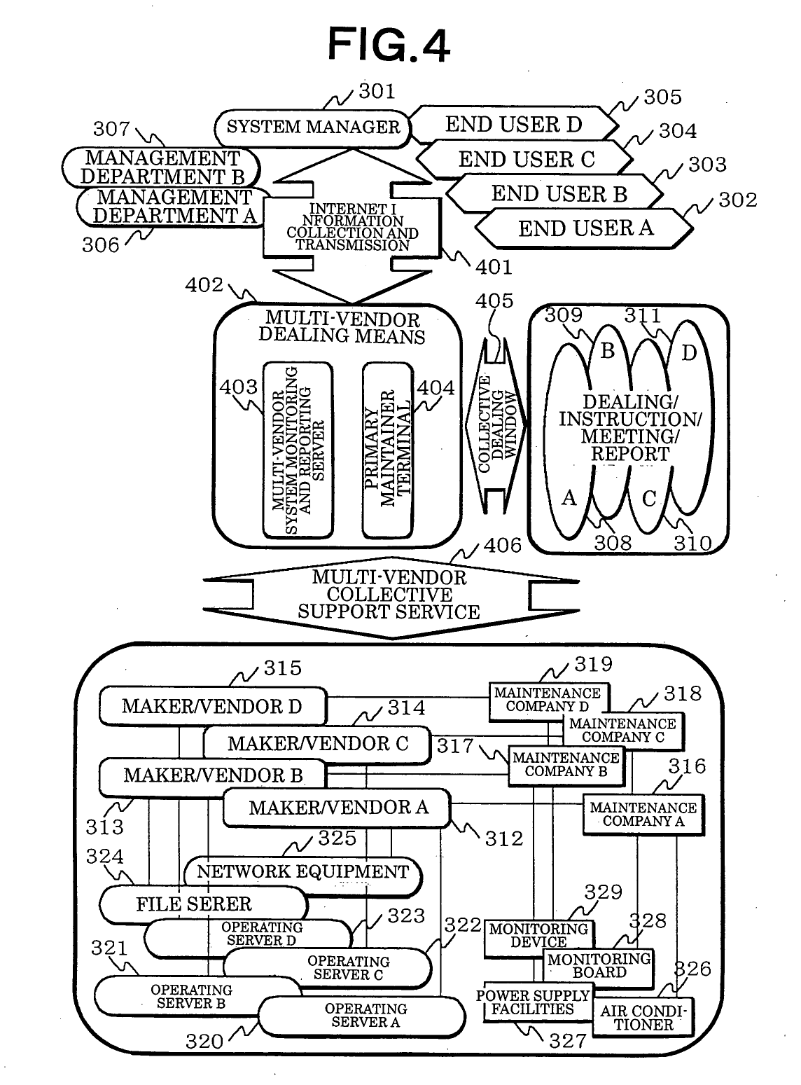

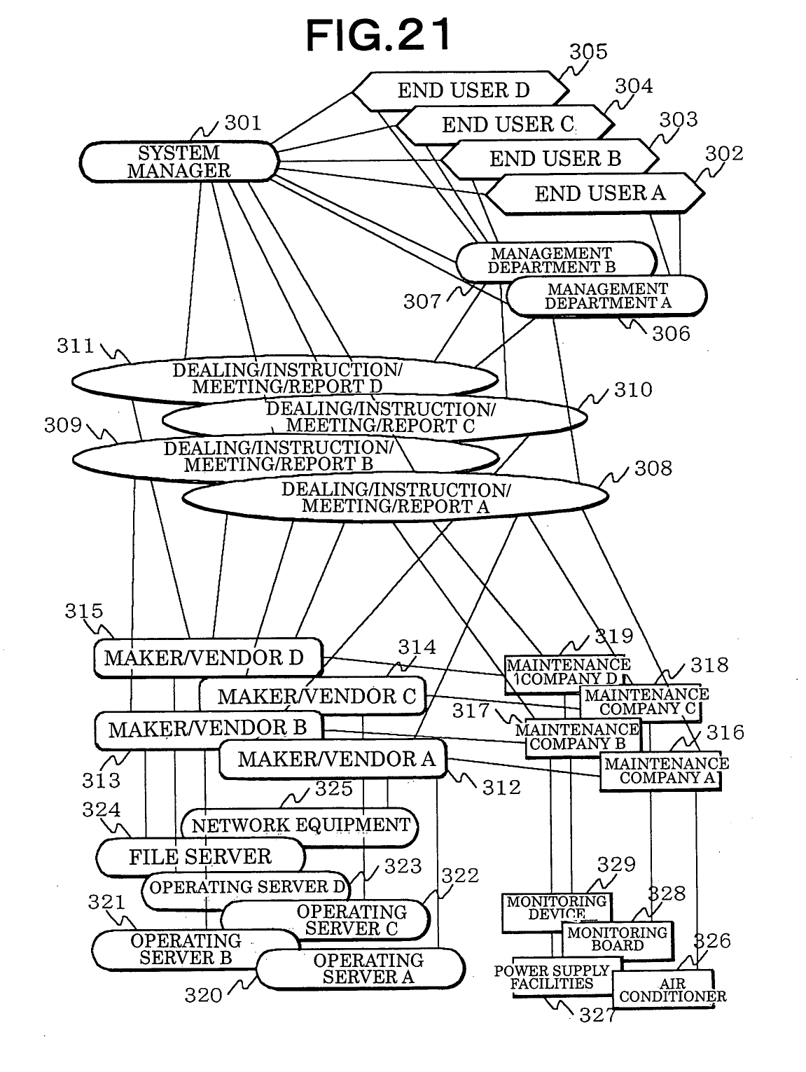

This relationship will be further described in more detail with reference to FIG. 4. FIG. 4 is a diagram showing a method of handling the complicatedly-associated multi-vendor system shown in FIG. 21 as a single vendor system.

First, information transmission collection represented by connection association lines' at the system user side, that is, among the system manager 301, the end user A 302 to the end user D 305 and the management department A 306 to the management department B 307 shown in FIG. 21. is carried out by Internet information collection and transmission 401.

Furthermore, the respective makers/vendors, the respective server equipment, the respective network equipment, the respective maintenance service companies, and the respective incidental facilities are handled in one bundle, and the primary maintainer carries out a multi-vendor collective support service 406.

Furthermore, the primary maintainer serves as a collective leading window 405, and collectively deals with dealing/instruction/meeting/report A 308 to dealing/instruction/meeting/report D 311 in one bundle.

As described above, the primary maintainer uses the multi-vendor system monitoring and reporting server 403 as multi-vendor dealing means 402 and the primary maintainer terminal 404, and also uses the internet information collection and transmission (Web function, mail function) to collectively carry out maintenance services such as reporting/dealing/supporting, etc.

The system manager can concentrate on the original management business (for example, system tuning, change of job input queue constant, user registration certification management, etc. ) by outsourcing the maintenance-relating business work to the primary maintainer.

Next, an embodiment of the present invention will be described in detail with reference to the accompanying drawings.

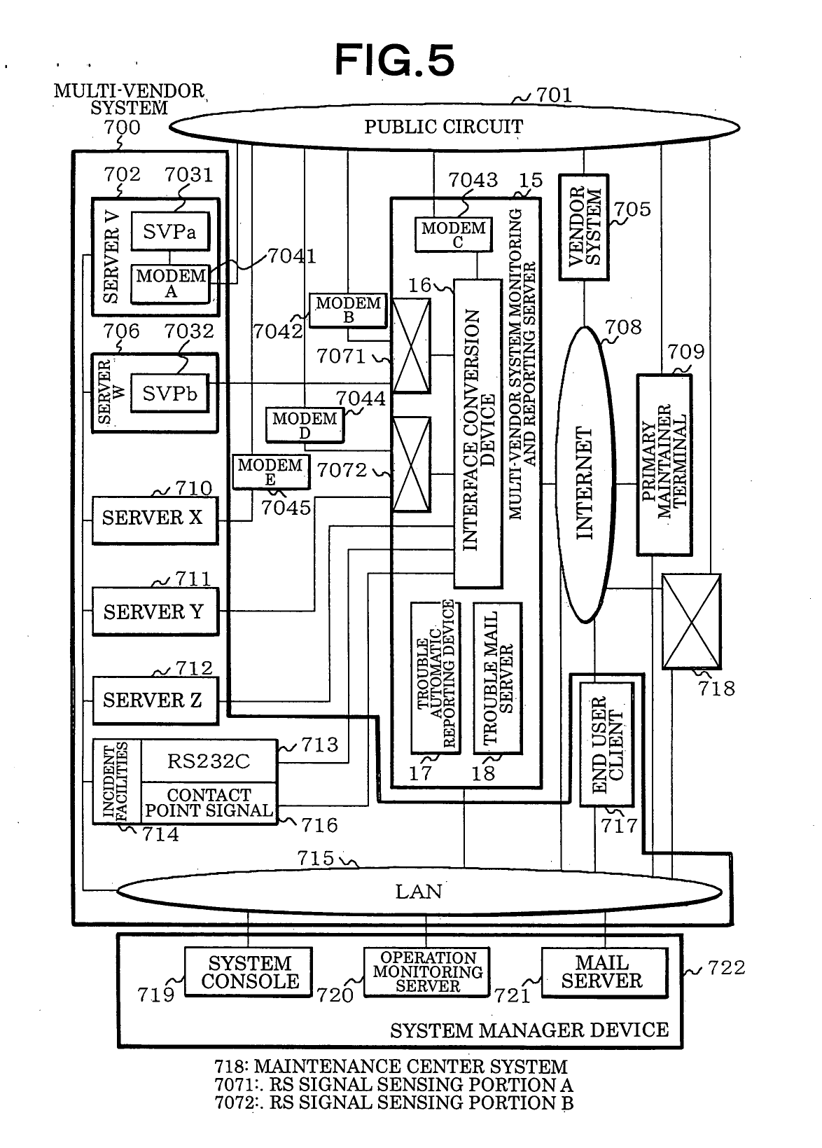

FIG. 5 is a block diagram showing the construction of a system according to an embodiment of the present invention.

Referring to FIG. 5, the system of this embodiment comprises a multi-vendor system monitoring and reporting server 15, a multi-vendor system 700, a public circuit 701, a vendor system 705, the Internet 708, a primary maintainer terminal 709, LAN 715, a maintenance center system 718, a system manager device 722, a modem b 7042, a modem d 7044, and a modem e 7045.

The multi-vendor system 700 is an example of the multi-vendor system, and it has a server V 702 containing SVP (service processor) a 7031 and a modem a 7041, a server W 706 containing SVPb 7032, a server X 710, a server Y 711, a server Z 712, incidental facilities 714, and an end user client 711.

The incidental facilities 714 contain an incidental equipment monitoring device having some degree of intelligent function, an incidental equipment monitoring board having lamp display or alarm buzzer, an air conditioning machine such as an air conditioner, and incident power equipment such as an uninterruptible power supply source for supplying power, and transmits signals (RS232C 713, connection signal 716) from the above elements to the interface conversion device 16 of the multi-vendor system monitoring and reporting server 15. For example, the connection signal 716 from the incident equipment monitoring board, the air conditioning equipment or the like and the RS232C serial interface signal 713 from the uninterruptible power supply source or the like are transmitted to the interface conversion device 16 in the multi-vendor system monitoring and reporting server 15.

The multi-vendor system monitoring and reporting server 15 is an information processing device operating under the control of a program, and it has an interface conversion device 16, a trouble automatically reporting device 17, a trouble mail server 18, a modem c 7043, an RS signal sensing portion a 7071 and an RS signal sensing portion b 7072. Furthermore, it is connected through the Internet 708, the public circuit 701 or LAN 715 to the multi-vendor system 700, the primary maintainer terminal 709, the vendor system 705, the maintenance center system 718 and the system manager device 722. The multi-vendor system monitoring and reporting server 15 detects a trouble in the multi-vendor system 700, and reports trouble information to the primary maintainer terminal 709, the system manager device 722, the vendor system 705 and the maintenance center system 718. Furthermore, the multi-vendor system monitoring and reporting server 15 has the following means (functions):
mail means for creating electronic mails and transmitting/receiving electronic mails;
web means for creating a web content and presenting the web content;
means for creating and displaying the status of each equipment constituting the multi-vendor system;
means for creating and displaying a graph between temperature and humidity at a setup place of the multi-vendor system;
means for displaying a diagram showing the construction of the multi-vendor system and changing the color of equipment to red when a trouble occurs in the equipment, and means for ringing an alarm;
means for displaying the monitored state of the color variation display function and alarm ringing function of the device under trouble on a screen at all times;
means for monitoring the use amount of a stream buffer of a server of the multi-vendor system so as to prevent occurrence of such a case that the stream buffer lacks and thus there occurs such a trouble that “log-in to an operating server by a general user is impossible, and it is impossible to refer to user's name/group's name at NIS (Network information system); and
means for achieving values (the number of jobs, the maximum used memory amount, the disc used capacity, etc.) indicating the operation condition of the multi-vendor system from the server, etc.

The above means (functions) may be equipped to the primary maintainer terminal 709, or may be shared to the multi-vendor system monitoring and reporting sever 15 and the primary maintainer side 709.

The interface conversion device 16 is adapted to various different interface signal. It is supplied with trouble information received by the modem c 7043, RS signals sensed by the RS signal sensing portion a 7071 and the RS signal sensing portion b 7072, or a contact point signal 716, and subjects these signals to interface conversion to recognize a trouble. On the basis of the trouble information thus recognized, trouble message conversion/addition is carried out, and then the conversion/addition result is transmitted to the trouble automatic reporting device 17 or the trouble mail server 18.

The trouble automatic reporting device 17 reports to the vendor system 705, the primary maintainer terminal 709 or the like troubles of the respective server devices, etc. on the basis of the RS232C serial interface signal input from the server Z 712 or clients to the interface conversion device 16, the RS232C serial interface signal 713, the trouble sensing contact point signal 716 from the incidental facilities 714, a trouble sensing condition based on a message to the multi-vendor system monitoring and reporting server 15 through LAN 715 if occasion demands. The trouble automatic reporting device 17 has the following functions.

(1) The trouble automatic reporting device 17 uses a public circuit (modem) connection. In the case of a LAN/network (router, hub or the like) relating trouble, a network equipment trouble or a communication medium trouble such as optical cable breaking or the like, the automatic reporting device 17 reports the trouble through the public circuit 701.

(2) Under the public circuit or dial-up communication, it is sufficient to communicate with at least one place or make ringing sounds of some telephone to leave a number notification of the calling source. At any rate, it is notified to the primary maintainer terminal 709, the vendor system 705, the maintenance center system 718 that some trouble abnormality occurs.

(3) The meaning and content of the reporting mainly aims to call attention to occurrence of some trouble. The communication content, the communication destination, the processing at the reception side are limited to only the matters concerning the trouble.

(4) With respect to mail reporting, there is a case where it is not perceived that a report (of a trouble) comes to a repot distribution destination, or there is a case where a report is mixed with other mails received and thus it is easily overlooked that the report indicates a trouble notification. Therefore, the trouble automatic reporting device 17 complements the mail reporting.

(5) The trouble automatic reporting device 17 is provided with a security function when trouble logs, diagnoses, etc. are collected, and external and remote monitor access communication (the same function as the direction access to SVP) is carried out (mainly, the function in the case of the server Y and the server Z of FIG. 5 is assisted).

The trouble mail server 18 reports to the vendor system 705, the primary maintainer terminal 709, the system manager device 722, etc. the troubles of the server devices, etc. based on the trouble message transmitted from the interface conversion device 16, the trouble sensing condition based on the message to the multi-vendor system monitoring and reporting server 15 through LAN 715, etc. Furthermore, the trouble mail server 18 performs the mail function, holds and renews a mailing list and selects a mail transmission destination, etc. Furthermore, the trouble mail server 18 has means for monitoring log files such as trouble message logs of server devices constituting the system and system message logs at all times, timely search character spellings of trouble-relating terms such as “DANGER”, etc. which mean troubles to sense the trouble, and then transmits the trouble to the primary maintainer terminal 709. The trouble mail server 18 has the following functions.

(1) On the assumption that the Internet function of the system in which a trouble occurs is normal and also distribution of an electronic mail is allowed, the trouble mail server 18 simultaneously distributes (broadcasts) an electronic mail to all or some group of many report distribution destinations such as the primary maintainer, the end users, the system manager, the maintenance companies, etc. on the basis of the mailing list.

(2) The trouble mail server 18 distributes a message having a content which cannot be reported by the trouble automatic reporting device 17 and is some degree of detailed content, but comprehensible by even a unspecialized person.

(3) The trouble mail server 18 timely distribute (broadcasts) an in-progress report of a trouble, a trouble dealing completion estimated time, a damage, a restriction matter, the dealing progress of the trouble dealing work carried out at the trouble site and dealing results.

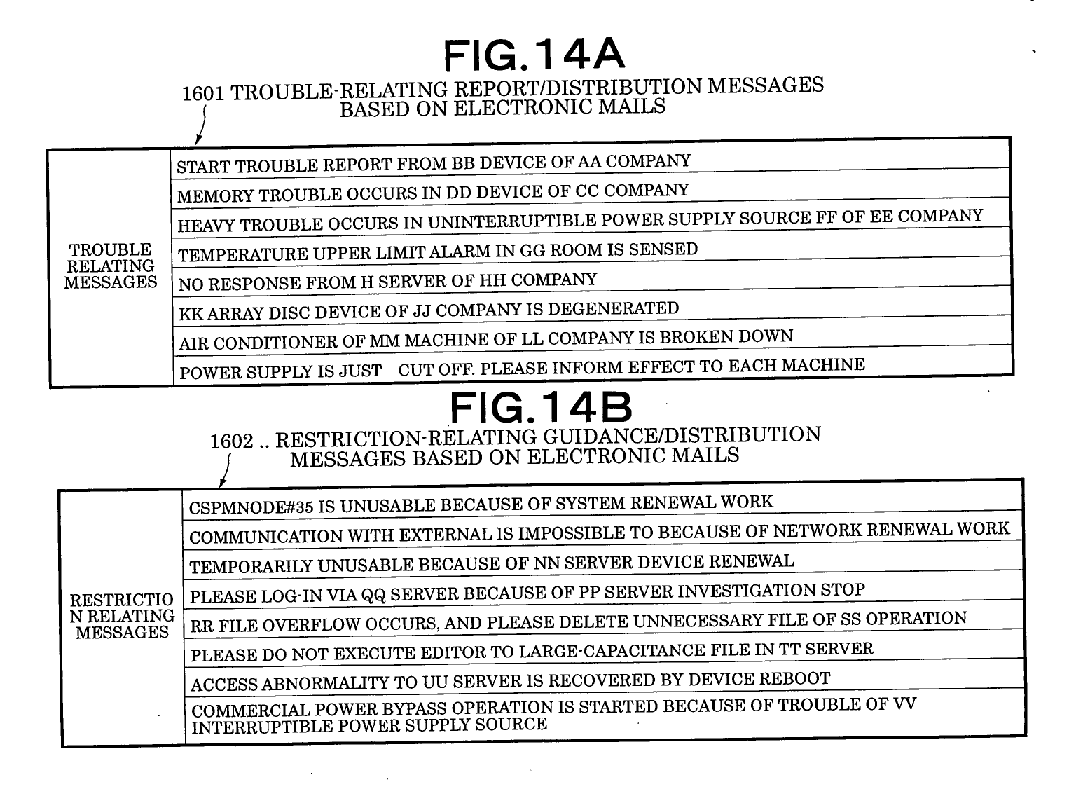

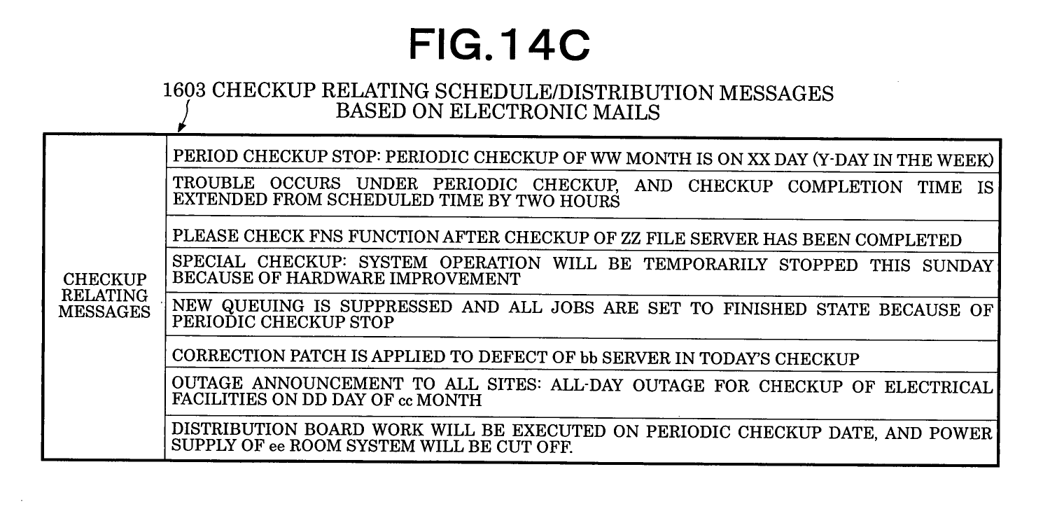

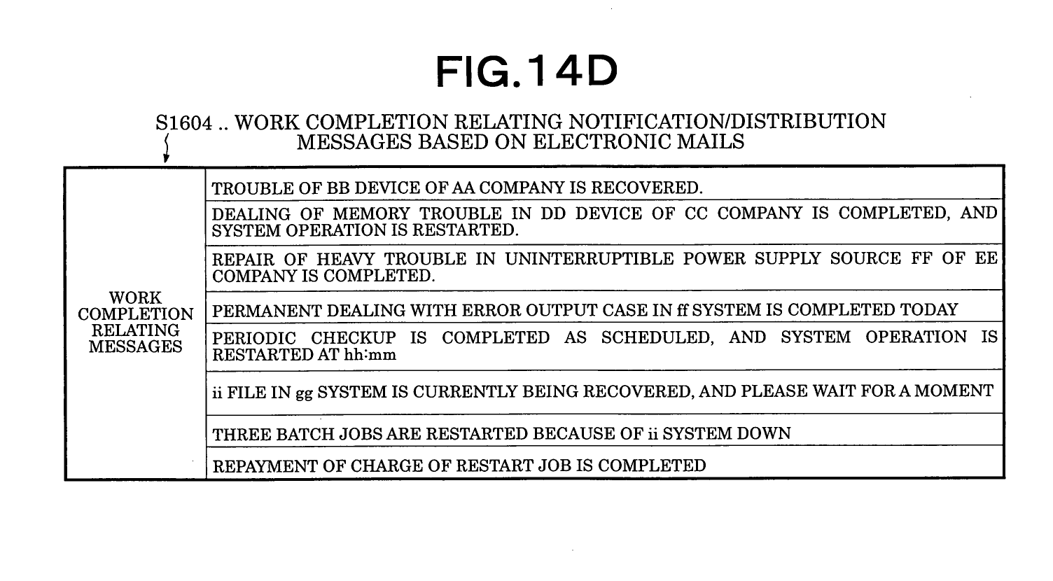

(4) The trouble mail server 18 distributes management operation information, check date information, a notification of extension of check completion estimated time (the content of FIG. 14), etc.

(5) The trouble mail server 18 has a message board, electronic blackboard function associated with the troubles.

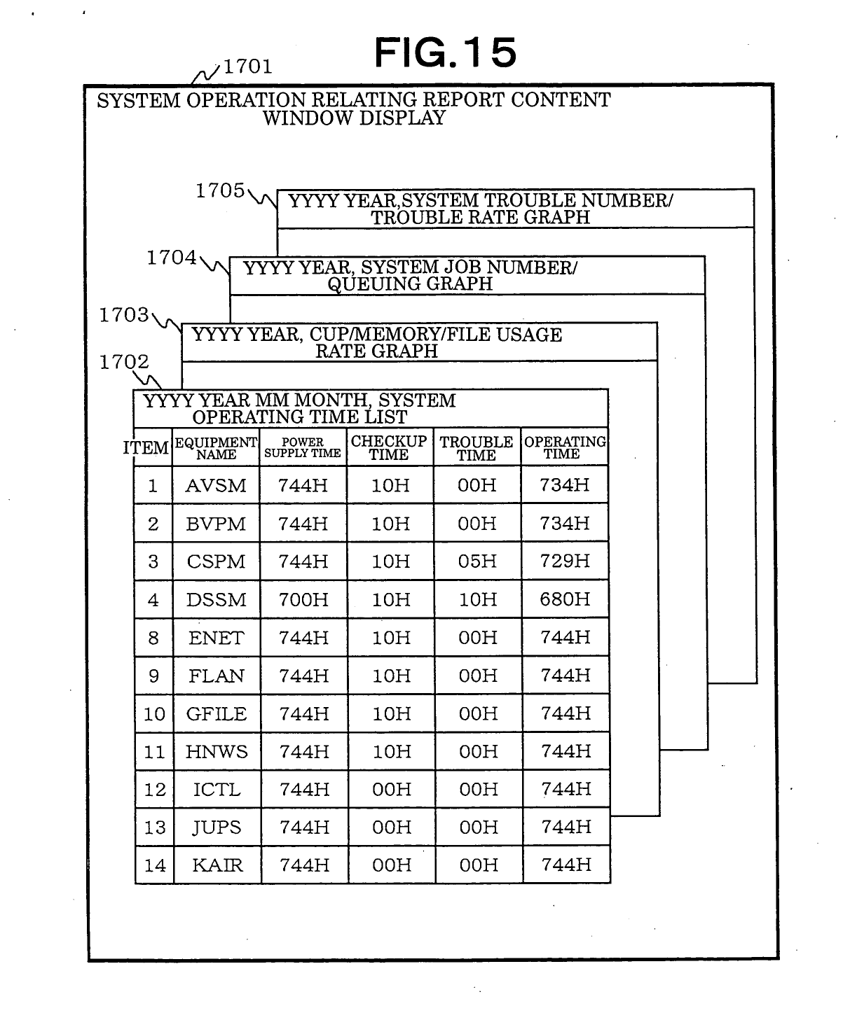

(6) The trouble mail server 18 discloses (transmits) information such as operation management, relevant information, etc. (FIGS. 15 to 18).

The modem c 7043 receives a trouble message from a server device through the public circuit 701.

The RS signal sensing portion a 7071 senses the RS transmission request signal out of the DTE interface signal of the modem b 7042, and transmits the RS transmission request signal thus sensed to the interface conversion device 16.

The RS signal sensing portion b 7072 senses the RS transmission request signal out of the DTE interface signal of the modem d 7044, and transmits the RS transmission request signal thus sensed to the interface conversion device 16.

The primary maintainer terminal 709 is an information processing device such as a personal computer or the like which is operated under the control of a program. It is connected to the multi-vendor system monitoring and reporting server 15 through the public circuit 701 or LAN 715, and also connected to the multi-vendor system 700. The primary maintainer terminal 709 servers as a maintenance window, and managed and operated by the primary maintainer having charge of primary maintenance. The primary maintainer terminal 709 has a function of receiving trouble information reported from the multi-vendor system monitoring and reporting server 15, a function of instructing trouble solution and progress reports to the vendor system 70, etc. associated with the trouble by an electronic mail, telephone or the like, a function of creating a document for reporting the trouble occurrence condition, the trouble solving condition, etc. and transmitting the document to the parties concerned through the mail function of the multi-vendor system monitoring and reporting server 15, a function of creating a web content of system operation management information such as an operation past record, periodic checkup information, etc. and registering the Web content in the Web function of the multi-vendor system monitoring and reporting server 15 so that the Web content can be viewed by a Web browser, a function of making an adjustment between the user side such as the system manager, etc. and the system equipment supply side (for example, adjustment on the meeting schedule, etc.), etc. Furthermore, the primary maintainer terminal 709 has means for collecting servers and error logs of SVP and means for remotely accessing the servers and SVP from the external.

The primary maintainer terminal 709 may be set up at any place, for example, at a place where the multi-vendor system monitoring and reporting server 15 exists, in the vendor system 705, in the maintenance center system 718, at a dedicated setup place or in a mobile. Furthermore, the primary maintainer terminal 709 is connected to the vendor system 705, the maintenance center system 718, the system manager device 722, etc. through the Internet 708, the public circuit 701, LAN 715 or the like.

The vendor system 705 is a system of a vendor which has supplied equipment constituting the multi-vendor system 700. The vendor system 705 receives trouble information automatically-reported from the supplied equipment, and also received trouble information reported from the multi-vendor system monitoring and reporting server 15. Furthermore, it receives an instruction on the trouble solution and progress reports from the primary maintainer terminal 709, carries out the trouble solution dealing work and transmits the progress report and the solution report to the primary maintainer terminal 709. The vendor system 705 is provided every vendor supplying each equipment. The vendor system 705 may also serve as the maintenance center system 718.

The maintenance center system 718 is the system of each maintenance center for doing maintenance of supplied equipment, and maintenance parts such as exchange parts, consumable parts, etc. are stocked in the maintenance center. The maintenance center system 718 exists every maintenance company having charge of the maintenance for the supplied equipment. The maintenance center system 718 may also serve as the vendor system 705.

The system manager device 722 is managed and operated by the system manager, and has a system console 719, an operation monitoring server 720 and a mail server 721. The system manager device 722 is connected to the multi-vendor system 700 and the multi-vendor system monitoring and reporting server 15 through LAN 715.

The system console 719 is a system operating device having a function of displaying a message from the operating system of each server device, a function of responding to an inquiry from the operating system, etc. The system console 719 is also a monitoring device of the system manager. The system console 719 has the following functions.

(1) The system console 719 puts in a system start-up operation (start-up command).

(2) The system console 719 puts in a system stop operation (shut-down command).

(3) The system console 719 displays a message under start-up which is called as ISL (Initial System Loading) or BOOT LOAD.

(4) The system console 719 displays a disc (file) scan message at a start-up time after irregular stop.

(5) The system console 719 displays a system trouble message.

(6) The system console 719 displays an error message of a network file (for example, “network file is unreadable”, “no response from file server”, etc.).

(7) The system console 719 displays an operation start command, network on line, an access (start of use) permission command of end users.

(8) The system console 719 displays automatic degeneration of multi-CPU, disc array, automatic restart-up, success or failure of retrial.

(9) The system console 719 displays a trouble-relevant message from each server device, etc.

The means for transmitting the trouble condition (message) between the system console 719 and the multi-vendor system monitoring and reporting server 15 may be as follows.

(A) The multi-vendor system monitoring and reporting server 15 itself may also serve as the console function, and sense a trouble by receiving a trouble message.

(B) A console message is delivered as a message from the system console 719 to the multi-vendor system monitoring and reporting server 15.

(C) A console message is written in a file by the system console 719, and the file is read out by the multi-vendor system monitoring and reporting server 15

The operation monitoring server 720 has means for displaying on a screen the monitored status of a color variation display function and an alarm ringing function of a trouble occurrence device equipped in the multi-vendor system monitoring and reporting server 15 through the LAN communications with the multi-vendor system monitoring and reporting server 15. The operation monitoring server 720 has the following functions.

(1) The operation monitoring server 720 registers, acknowledges, allows, alters and cancels IDs of end users. For example, the operation monitoring server 720 carries out: registration renewal every year, charging (CPU use-allowed term, memory use-allowed term, disc file capacity permissible value) grasp of IDENT-basis track records, group affiliation of IDENT: setting of group IDENT;
grasp of annual resource-use request application and usage track records (which is used as a standard for allowance in next year);
deletion (exclusion) of IDENT of unjust, dishonest users;
setting of IDENT use-allowed term, warning of time-over of allowance, compulsory stop of use;
change of setting of available resources for specially-allowed jobs, projects, and setting of IDENT;
warning to persons over regular charges and stop of use;
allowance of reapplication of persons over regular charges and change the charge for available resources; and
change and renewal of charges.

(2) The operation monitoring server 720 accepts use of the system, keeps the gate and monitors use of the system.

(3) The operation monitoring server 720 cooperates with a server such as a log-in server to restrict or prioritize effective use of the system and suppression of unfairness to users (at log-in time).

(4) The operation monitoring server 720 manages to share users to respective servers (intentionally).

(5) The operation monitoring server 720 indicates IDENT (containing an indication of job queue) for developing programs.

(6) The operation monitoring server 720 indicate job IDENT (containing an indication of job queue) of test run.

(7) The operation monitoring server 720 sets preferential jobs in accordance with season.

(8) The operation monitoring server 720 manages priorities of users.

The mail server 721 receives a trouble message and carries out broadcast distribution to end user clients 717. Furthermore, the mail server 721 carries out instructions to the overall system, that is, transmission of periodic schedule information, transmission of system operation stop information for annual renewal of registered user IDs, transmission of regular meeting contents with vendors, transmission of instructions to the end user clients 717, communications for business such as accept of inquiries, etc. Furthermore, it serves as a monitor server for monitoring whether a trouble mail distributed from the multi-vendor system monitoring and reporting server 15 is properly distributed or not. With respect to the transmission of the periodic checkup schedule information, the primary maintainer makes meetings with respective vendors about the periodic checkup schedule and the process flow, and transmits the results to the operation monitoring server 720 for final acknowledgement and confirmation. The transmission to the end users is carried out by the operation monitoring server 720 and the mail server 721. Furthermore, the annual renewal of the registered user IDs is wholly carried out by the operation monitoring server 720, and the primary maintainer transmits operation stop date and time from the multi-vendor system monitoring and reporting server 15 to vendors/makers concerned. Furthermore, with respect to the regular meeting content with vendors, the primary maintainer holds regular meetings, fix the resolution content and transmits it to the operation monitoring server 720. Only the primary maintainer attends the regular meetings with the system manager. As occasion demands, the makers/vendors (secondary maintainers) share a table with the primary maintainer to participate in the discussions. The transmission of instructions to the end users 717 and the communications for business such as accept of inquires, etc. are carried out by operation monitoring server 720 and the mail server 721. Accordingly, the mail distribution from the multi-vendor system monitoring and reporting server 15 is mainly carried out on the system manager device, each maintenance center system and each vendor system, and the mail distribution to the end user clients is mainly carried out by the operation monitoring server and the mail server.

Here, the connection between the multi-vendor system monitoring and reporting server 15 and the multi-vendor system 700 and a trouble recognizing system will be described.

The multi-vendor system monitoring and reporting server 15 is set up in the neighborhood of the setup place of the multi-vendor system 700, and connected to the respective constituent devices of the multi-vendor system 700. That is, the server V702, the server W706, the server X 710, the server Y 711, the server Z 712, the incidental facilities 714 and the multi-vendor system monitoring and reporting server 15 are connected to one another, and the multi-vendor monitoring and reporting server 15 converts signals transmitted from different interfaces by the interface conversion device 16 to recognize occurrence of troubles.

A first system for signal conversion and recognition is as follows in the case of the server V 702, a trouble is recognized by SVPa 7031, and the recognition result (trouble information) is reported from the modem a 7041 to the public circuit. At this time, when SVPa 7031 can set, at a time, plural places as reporting destinations to which trouble information is simultaneously reported (for example, the vendor system 706 as a primary reporting destination, the multi-vendor system monitoring and reporting server 15 as a secondary reporting destination) and also the communication protocols of the reporting destinations are coincident with one another, it reports the trouble information from the modem a 7041 of SVPa 7031 of the server V 702 through the public circuit 701 to the vendor system 705 as the primary reporting destination. Furthermore, the server V 701 connected to the modem c 7043 of the multi-vendor system monitoring and reporting server 15 as the secondary reporting destination to report to the multi-vendor system monitoring and reporting server 15, whereby the trouble information is successively reported to the two places at a time and both the vendor system 705 and the multi-vendor system monitoring and reporting server 15 recognizes the trouble. The multi-vendor system monitoring and reporting server 15 reports the trouble information to the external (for example, the primary maintainer terminal 709, etc.).

A second system is as follows in the case of the server W 706, when SVPb 7032 of the server W 706 can set only one place as a reporting destination or when SVPb 7032 can set two places as reporting destinations, but the communication protocols are not coincident with each other, the DET cable serving as the interface cable between SVPb 7032 and the modem b 704 is relayed at the multi-vendor system monitoring and reporting server 15. At this time, the RS transmission request signal out of the DTE interface signal of the modem b 7042 is sensed at the RS signal sensing portion a 7071, whereby the multi-vendor system monitoring and reporting server 15 recognizes occurrence of a trouble. In this case, the reporting destination is only one place of the vendor system 705, and the multi-vendor system monitoring and reporting server 15 cannot achieve the message content of the trouble although it senses only the fact that the RS transmission request signal is set to ON. Therefore, a trouble message representing an event that a report of some trouble of the device concerned is started is added and transmitted from the multi-vendor system monitoring and reporting server 15 to the external (for example, the primary maintainer terminal 709, etc.).

A third system is as follows. In the case of the server X 710, the server X 710 has no SVP, but it connects to the public circuit 701 through the modem e 7045 by the function of the operating system and reports trouble information by the communication software of the operating system. In this case, the operating system of the server X 710 senses a trouble, and reported the trouble information through the modem e 7045 to the public circuit 701. Furthermore, the operating system can set, at a time, plural reporting destinations of the trouble information (for example, the vendor system 705 serving as the primary reporting destination, the multi-vendor system monitoring and reporting server 15 as the secondary reporting destination) and also the communication protocols thereof are coincident with each other. In this case, the server X 710 reports from the modem e 7045 thereof through the public circuit 701 to the vendor system 705 as the primary reporting destination, an also connects to the modem c 7043 of the multi-vendor system monitoring and reporting server 15 as the secondary reporting destination to report the trouble information to the multi-vendor system monitoring and reporting server 15. That is, the trouble information is successively transmitted to the two places at a time in a software reporting mode, so that the vendor system 705 and the primary maintainer terminal 709 recognize the trouble as in the case of the first system.

A fourth system is as follows. In the case of the server Y 711, when the server Y 711 can set only one place as a reporting destination in the software reporting mode or when it can set two places as reporting destination, but the communication protocols thereof are not coincident with each other, the DTE cable serving as the interface cable between the server Y 711 and the modem d 7044 is relayed at the multi-vendor system monitoring and reporting server 15. At this time, the RS transmission request signal out of the DTE interface signal of the modem d 7044 is sensed at the RS signal sensing portion b 7072, whereby the multi-vendor system monitoring and reporting server 15 recognizes occurrence of a trouble. At this time, the reporting destination is only one place of the vendor system 705, and the multi-vendor system monitoring and reporting server 15 cannot know the trouble content, and senses only the fact that the RS transmission request signal is set to ON. Therefore, a trouble message representing an event that a report of some trouble of the device concerned is started is added and transmitted from the multi-vendor system monitoring and reporting server 15 to the external (for example, the primary maintainer terminal 709, etc.)

A fifth system is as follows. When equipment such as the server z 712, a client or the like has a little intelligent function, for example, it has an RS232C serial interface based on control sequence or the like, a message signal of device abnormality transmitted from the server Z 712 is transmitted to the interface conversion device 16 of the multi-vendor system monitoring and reporting server 15, and a trouble message representing an event that a report of some trouble of the device concerned is started is added and transmitted from the multi-vendor system monitoring and reporting server 15 to the external (for example, the primary maintainer terminal 709, etc.).

A sixth system is as follows. With respect to a trouble notifying signal in the case of the incidental facilities 714, an RS232C serial interface signal 713 from a program sequence equipped to an environmental control monitoring board or the like in a computer room and an alarm contact point signal 716 for closing the contact point at the trouble time or opening the contact point at the normal time are transmitted to the interface conversion device 16 of the multi-vendor system monitoring and reporting server 15, added with trouble messages corresponding to the respective signals in the multi-vendor system monitoring and reporting server 15 and then notified to the external (for example, the primary maintainer terminal 709, etc.).

When plural trouble reporting destinations can be set as described above, the priority order of the transmission destinations of the report, that is, which one of the multi-vendor system monitoring and reporting server 15 and the vendor system 705 has priority is determined in accordance with the necessity such as the trouble maintenance system, the importance degree of the processing content of the server device, etc.

Furthermore, since each of the server device, etc. described above has an interface to LAN 715, each server device may have means for transmitting the trouble notification information to the multi-vendor system monitoring and reporting server 15 through LAN 715, and transmit the trouble information to the multi-vendor system monitoring and reporting server 15 through LAN 715.

Conversely, in order to check the normal operation from the multi-vendor system monitoring and reporting server 15 to each server device, the multi-vendor system monitoring and reporting server 15 may have means for carrying out health-check based on a program using a remote command through the network.

When a trouble-relevant message, for example, a message containing a trouble term such as “DANGER”, “ALERT”, “CAUTION”, “WARNING”, “ATTENTION”, “ERROR”, “PANIC”, “DOWN” or the like is output from each server device to the system console 719, the operation monitoring server 720 or the mail server 718, each server device, the operation monitoring server 720, the mail server 718 or the system console 719 may have means for detecting these terms and transmitting a trouble message through LAN 715 to the multi-vendor system monitoring and reporting server 15 or the primary maintainer terminal 709.

Next, the operation of this embodiment according to the present invention will be described in detail with reference to the accompanying drawings.

The operation when the trouble is monitored and reported (the trouble is monitored and reported to the primary maintainer or the vendor) will be first described with reference to FIGS. 5 to 7.

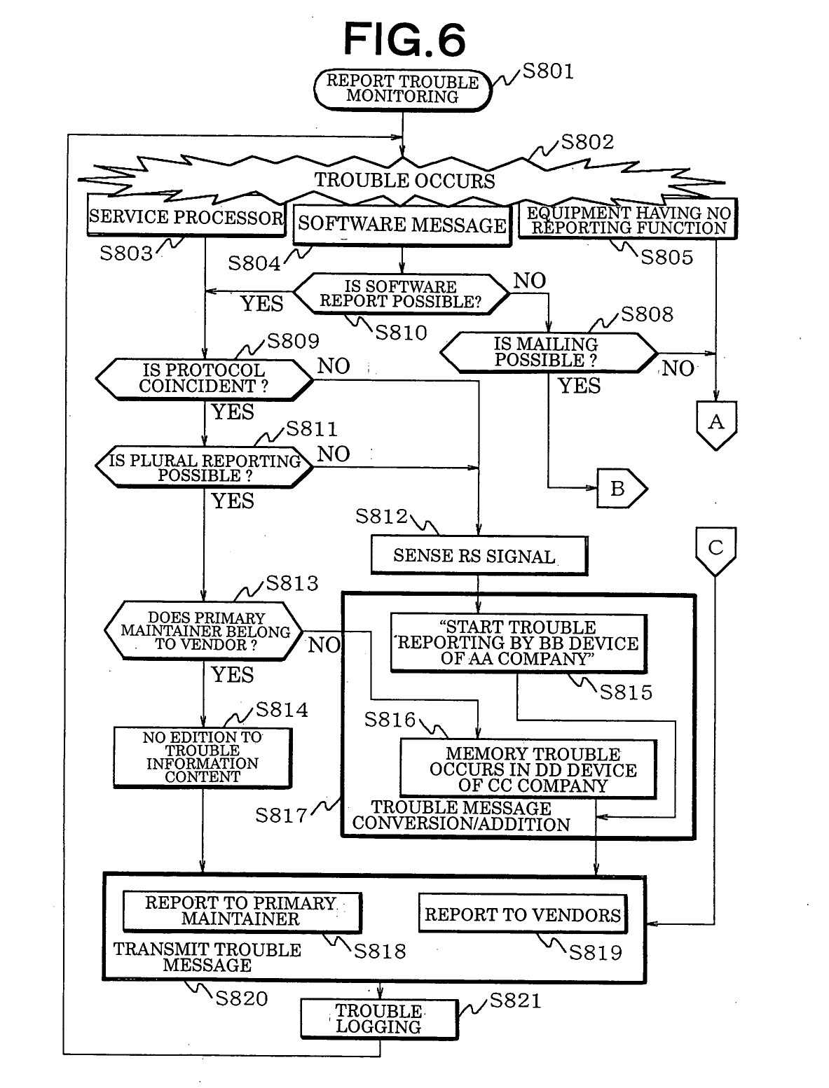

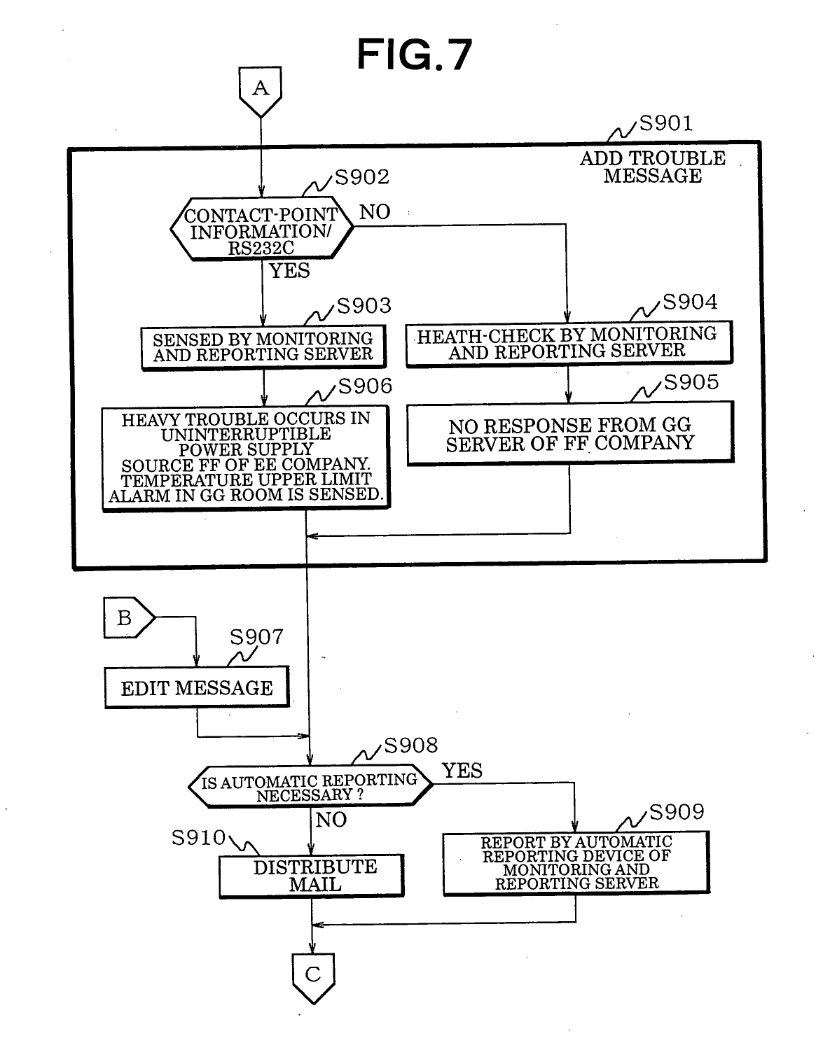

FIGS. 6 and 7 show the operation flow when the trouble is monitored and reported.

Referring to FIG. 6, in the trouble monitoring and reporting operation, troubles occurring irregularly in the server devices and the incidental facilities (step S802) are monitored at all times.

First, when such a trouble that the function of the service processor (step S803) equipped to each server device is made to work occurs in the server device, the server device itself may be stopped with high probability. Accordingly, it is impossible to report trouble information through LAN 715 or the Internet 708, and thus the trouble information is reported through the public line 701 to the vendor system 705, the multi-vendor system monitoring and reporting server 15, the primary maintainer terminal 709 or the relevant maintenance center system 718 by using the connection based on the modem a 7041 to the modem e 7045.

The function of the service processor (step S803) at the reporting time is dependent on the hardware itself, and thus it is based on the unique specification of each vendor in many cases. When the primary maintainer belongs to a vendor supplying a server device (YES in step S813) , the trouble information is reported to plural places such as the vendor system 705, the multi-vendor system monitoring and reporting server 15, etc. because the communication protocol of the service processor (S803) for trouble reporting is coincident (YES in step S809) in specification. Or, when the communication protocol of the service processor (step S803) for the trouble reporting is coincident (YES in step S809) although the primary maintainer does not belong to the vendor supplying the server device, the trouble information is reported to plural places such as the vendor system 705, the multi-vendor system monitoring and reporting server 15, etc. when the service processors can successively connect to two or more places as dial destinations of the public circuit, that is, can communicate with plural places (YES in step S811) as the function thereof. At this time, when the primary maintainer belongs to the vendor (YES in step S813), the trouble information content can be directly interpreted and thus a trouble message transmission step is carried out (step S820) with no edition (step S814) to report the trouble message to the primary maintainer terminal 709 (step S818).

Next, when the communication protocol of the service processor (step S803) to report the trouble is not coincident (No in step S809), that is, when the trouble report is communicated by using the protocol whose specification is unique to the vendor, or when the service process (step S803) can set only one place as a dial reporting destination to which the trouble report is notified, or when only one place (for example, the vendor) can be set as a reporting destination because of restriction imposed on the operation or the maintenance system, that is, when it is impossible to report to plural places (No in step S811), the RS transmission request signal of the DTE interface signal to the modem b 7042 or the modem d 7044 is sensed by the multi-vendor system monitoring and reporting server 15 (step S812). That is, the multi-vendor system monitoring and reporting server 15 senses only that the transmission request signal is set to ON, that is, it is merely recognized only that some reporting communication concerning a trouble is started, so that trouble message conversion/addition (step S817) is carried out in the multi-vendor system monitoring and reporting server 15. In the trouble message conversion/addition (step S817), the event that the RS transmission request signal of the modem b 7042 or modem d 7044 of the service processor (S803) is set to ON, which is sensed by the multi-vendor system monitoring and reporting server 15, is converted to a trouble message with which it can be identified that the transmission of the trouble report is started from which modem (i.e., the modem b 7042 or the modem d 7044) of which device of which vendor (for example, a message like “transmission of trouble report is started from BB device of AA company” (step S815)), and it is reported to the primary maintainer terminal 709 (step S818) in trouble message transmission step (step S820). It is needless to say that the trouble is automatically reported to the vendor systems 705 through the respective modems.

Next, when the primary maintainer does not belong to any vendor (No in step S814), the protocol of the service processor (step S803) for the trouble reporting is coincident (YES in step S809), and thus the reporting to plural places is possible (YES in step S811). Therefore, a trouble message from the service processor (step S803) is sent to the multi-vendor system monitoring and reporting server 15 as one of the reporting destinations, the trouble message conversion/addition (step S817) for adding a message like “memory trouble occurs in DD device of CC company” (step S816) is carried out by identification means for identifying which vendor the trouble message is indicated to, and then it is reported (step S818) to the primary maintainer terminal 709 (step S818) in the trouble message transmission step (step S820). In this case, it is possible to report to plural places (YES in step S8119, and thus the trouble report message from the service processor (step S803) is also reported to the vendor system 705 supplying the device concerned (step S819).

Next, a case where trouble reporting is carried out by a software message (step S804) will be described hereunder.

The software message (step S804) reporting case means a case where a trouble is not handled by the service processor (step S803) which mainly handles hardware troubles, or a case where when a server device has no service processor (step S803), the modem e 7045 is connected to the communication port of the basic function of the operating system equipped to the server device to automatically report a trouble message through the public circuit 701 through the public circuit 701. For example, there are a case where the server system goes down due to some bug of software, but the communication function suffers no effect of the software bug, a case where one of array discs of a peripheral processing device of the system has a breakdown and falls into a degeneration state, a case where it is impossible to carry out on-line network communications between servers, etc. The trouble reporting case based on the software message (step S804) through the communication using the modem e 7045 corresponds to a case where the basic portion of the operating system is operated to act in place of the function of the service processor (step S803), and the same processing as the service processor (step S803) is carried out. When the software-based reporting described above is possible (YES in step S810), the same processing as the service processor (step S803) described above is carried out along the processing of the coincident in protocol (step S809), the possibility of reporting to plural places (step S811) and the judgment as to whether the primary maintainer belongs to a vendor (step S813).

If the software-based reporting is impossible (NO in step S810), that is, if the server device has no function of communicating through the public line 701 by using its dedicated modem for automatically reporting the trouble, the server device uses the communication through LAN for the on-line access, that is, the mail communication function to report the trouble.

If mailing is possible (YES in step S808), the trouble is distributed to the multi-vendor system monitoring and reporting server 15 by using the mail function.

If mailing is impossible (NO in step S808), the equipment itself cannot transmit any message on the trouble, and thus the same processing for the trouble reporting as the equipment having no reporting function (step S805) is carried out.

When a trouble occurs in equipment having no trouble reporting function (step S805), for example when the signals from the incidental facilities 712 of the system are the contact point signals/RS232C (YES in step S902) (for example, a trouble signal from an uninterruptible power supply source, a trouble signal from an air conditioner, a signal from a room-temperature upper limit detecting sensor when the temperature of the room where a computer for monitoring environmental abnormality is setup exceeds the upper limit of a threshold value), it is detected by the multi-vendor system monitoring and reporting server 15 that these signals concerned are set to “ON” (step S903), and a trouble message is added (step S901) in connection with the monitoring result of a device for monitoring the terminal numbers of the terminal board of the interface conversion device 16 to which the above contact-point signals are input. For example, the contact-point signal from the uninterruptible power supply source is connected (input) to the terminal number 01, and a message “Heavy trouble occurs in uninterruptible power supply source FF of EE company” is added as the trouble message. In the case of the contact-point signal from the temperature upper limit sensor, a trouble message “Upper limit alarm of temperature in GG room is sensed” is added (step S901).

On the other hand, when the signal is not a contact-point signal/RS232C (NO in step S902), that is, when a system device has no service processor (step S803), software-based reporting is impossible (NO in step S810), the system device cannot distribute a trouble status by itself, but it is connected to LAN on-line, health-check as to whether the device is normally operated or not is carried out by using a remote command based on a program from the multi-vendor system monitoring and reporting server 15 (step S904), and a trouble message like “no response from GG server of FF company” (step S905) is added in accordance with the situation.

Furthermore, when in the software message step (step S804) software-based reporting via a dedicated modem for trouble reporting is impossible (NO in step S810),but the system device itself can mail trouble information by itself (YES in step S808), the message is edited by adding the trouble information with an item for identifying a vendor in the multi-vendor system monitoring and reporting server 15 as occasion demands (step S907).

When the message-edited information or the trouble-message added information achieved in the multi-vendor system monitoring and reporting server 15 as described above is required to be automatically reported through the public circuit 701 by the automatically reporting dedicated modem (YES in step S908), for example when an air conditioner as one of the incidental facilities 712 is broken down and thus completely stopped, so that the room temperature rises up and thus the actuation of the system is critically affected, when a trouble occurs in the power board of a network device working as an essential device for the system to makes on-line communications impossible, or when it is late to recognize trouble reporting destinations in the mail distribution, the trouble reporting is carried out by the trouble automatic reporting device 17 of the multi-vendor system monitoring and reporting server 15 (step S909).

As described above, the trouble monitoring and sensing operation and the trouble reporting operation are carried out.

Next, the trouble-condition transmitting operation after the trouble is monitored, sensed and reported, that is, the operation of transmitting the damage condition, the affected range, the dealing progress, recovery prospect, etc. will be described.

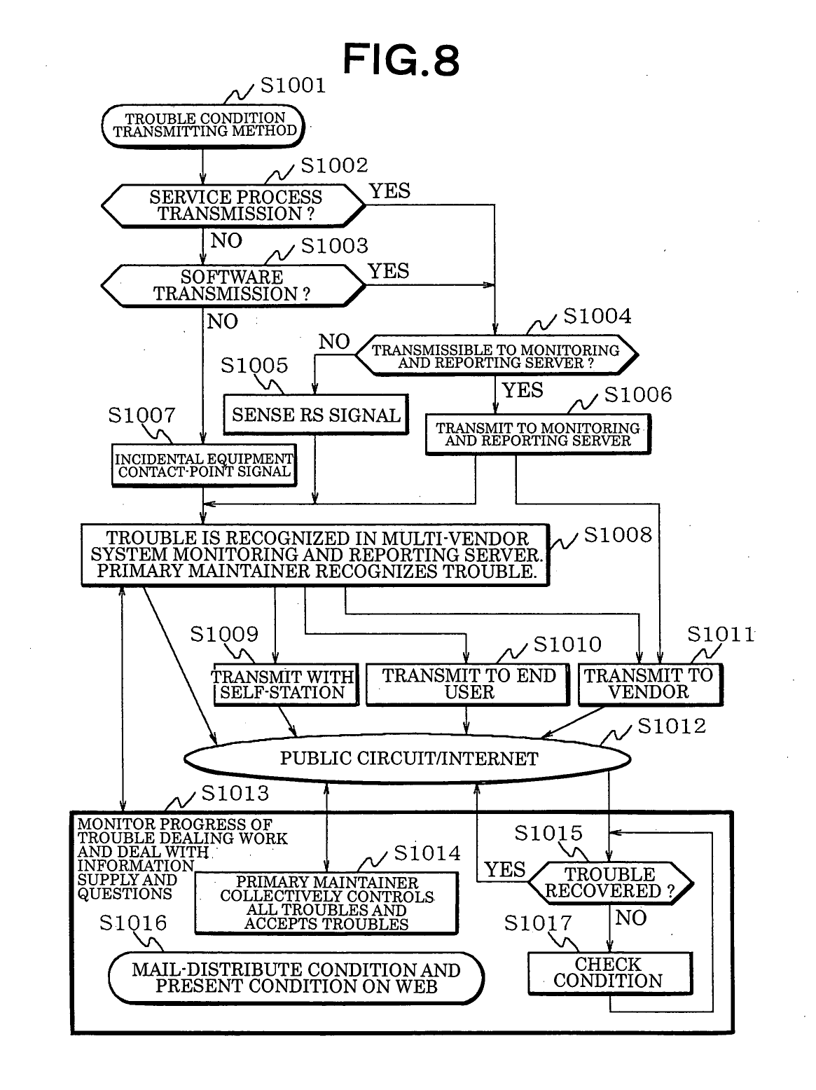

FIG. 8 is a diagram showing the operation flow when the trouble condition is transmitted.

In the following description, a method of distributing trouble information monitored and reported (step S801) in FIGS. 6 and 7 to parties concerned will be described.

When the trouble reporting is carried out from the service processor (YES in step S1002) and also the report from the service processor can be transmitted to the multi-vendor system monitoring and reporting server 15 (YES in step S1004), the transmission of the trouble information to the multi-vendor system monitoring and reporting server 15 (step S1006) and the transmission of the trouble information to the vendor system 705 (step S1011) are carried out.

Furthermore, when the software-based transmission can be performed as the function of the operating system (YES in step S1003) although the service processor has no transmission function (NO in step S1002) and also the trouble report can be transmitted to the multi-vendor system monitoring and reporting server 15 (YES in step S1004), the transmission of the trouble information to the multi-vendor system monitoring and reporting server 15 (step S1006) and the transmission of the trouble information to the vendor system 705 (step S1011) are carried out.

When the trouble information cannot be transmitted to the multi-vendor system monitoring and reporting server 15 through the communication protocol (NO in step S1004), the RS transmission request signal in the DTE signal of the modem is monitored and sensed in the multi-vendor system monitoring and reporting server 15 (step S1005). When no communication protocol is equipped, that is, when it is impossible to carry out the processor transmission (NO in step S1002) and also the software-based transmission is impossible (NO in step S1003) for example, the contact-point signal of the incidental equipment is sensed (step S1007), and the trouble is recognized in the multi-vendor system monitoring and reporting server 15 (step S1008).

The multi-vendor system monitoring and reporting server 15 transmits the trouble message to the primary maintainer, the system manager, the users and each management-relevant department (step S1009), transmits the trouble message to the end user clients 717 (step S1010) and transmits the trouble message to the vendor system 705, etc. (step S1011).

Furthermore, with respect to messages which the multi-vendor system monitoring and reporting server 15 cannot automatically detect and report/distribute, for example, the progress of the maintenance work for a trouble, a recovery expected time for the trouble, the damage condition of the trouble, a trouble recovery announcement, restriction items occurring due to the trouble, etc. (message contents shown in FIG. 14, etc.), the primary maintainer inputs distribution contents from the primary maintainer terminal 709, and distribute them through the mail function of the multi-vendor system monitoring and reporting server 15 by electronic mails.

Furthermore, the system manager inputs distribution contents at the operation monitoring server 720 and distribute them by electronic mails in accordance with the situation and the distribution message content.

The primary maintainer is in charge of all troubles to accept the troubles (step S1014), check the condition (step S1017) for trouble recovery (step S1015), monitor the dealing progress of the troubles, deal with the information supply and inquiries concerning the troubles (step S1013), distribute the trouble condition by electronic mails and presenting the trouble condition on Web (step S1016).

As described above, the trouble condition is notified to the parties interested according to the trouble condition transmitting method shown in FIG. 8.

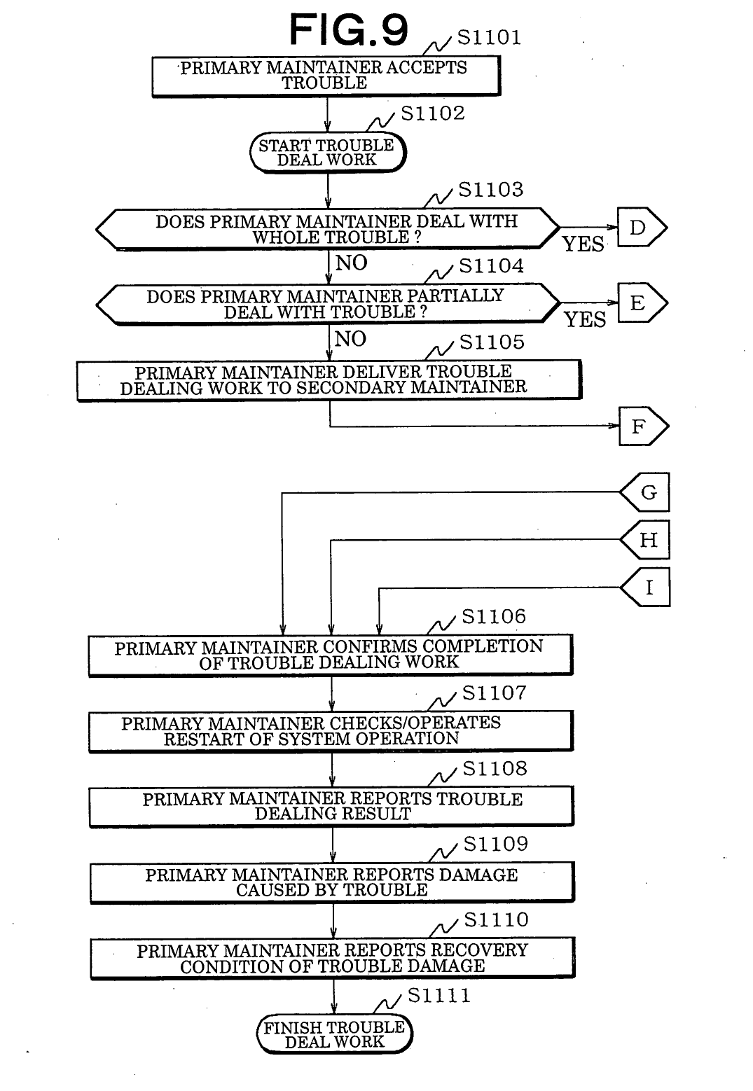

Next, the dealing work of the trouble maintenance will be described with reference to FIGS. 9 to 12.

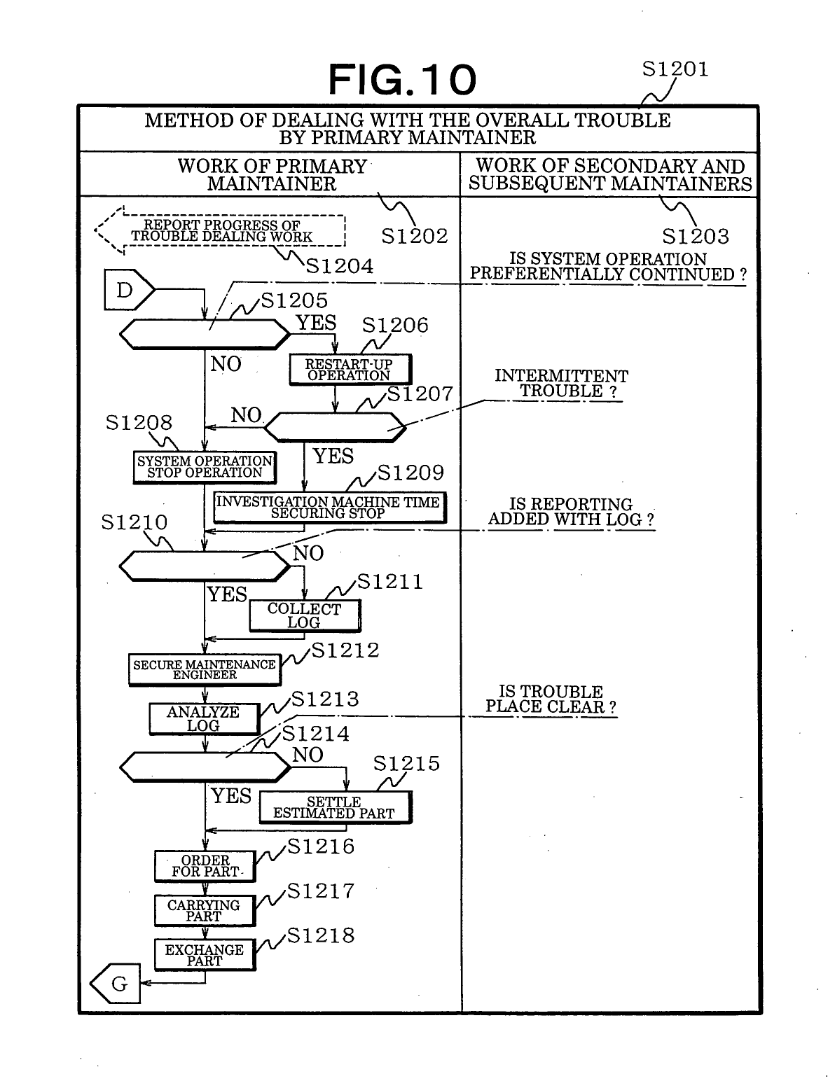

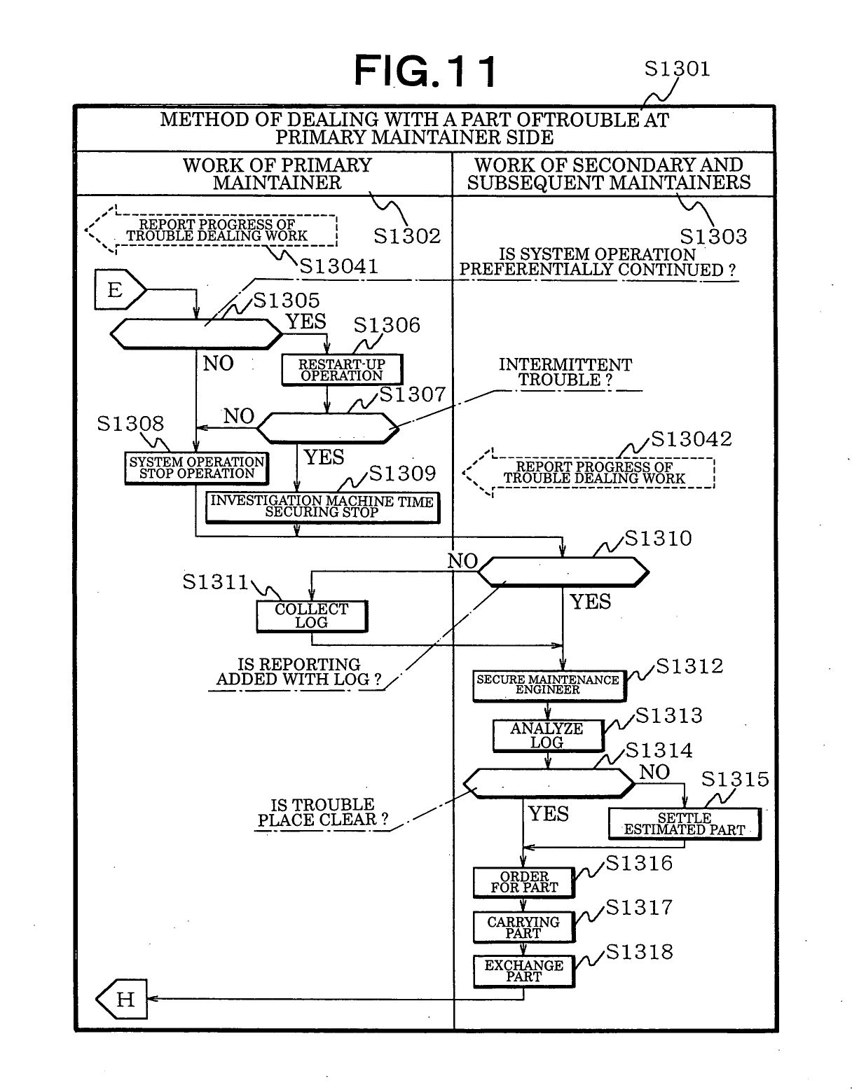

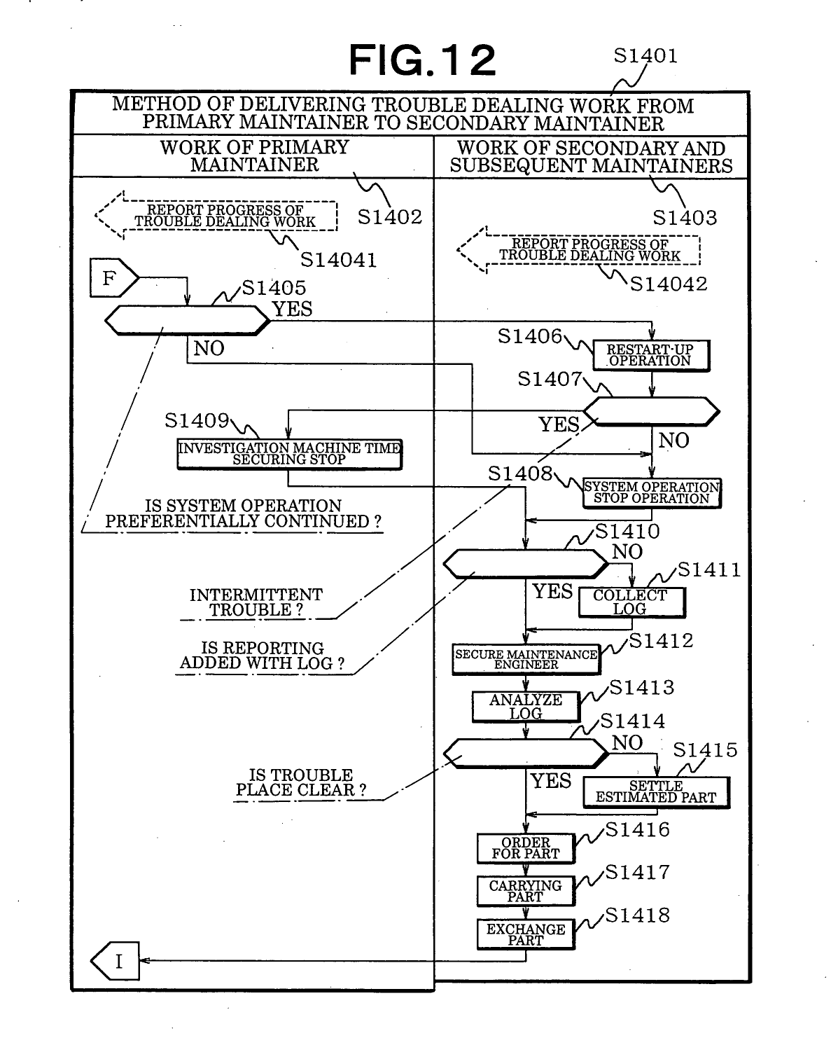

FIG. 9 is a diagram showing the overall flow of the dealing work of the trouble maintenance, FIG. 10 is a diagram showing the operation of a first method of the trouble dealing work, FIG. 11 is a diagram showing the operation flow of a second method of the trouble dealing work, and FIG. 12 is a diagram showing the operation flow of a third method of the trouble dealing work.

The operation shown in FIG. 8 in which the primary maintainer is in charge of all troubles and accepts the troubles (step S1014) corresponds to the operation in which the primary maintainer accepts troubles (step S1101) in FIG. 9, and it accepts troubles and starts the trouble dealing work (step S1102).

Here, the method of the trouble dealing work is roughly classified into three cases on the basis of the maintenance style, that is, the association of the server equipment and the incidental facilities with relationship of OEM products, agency of sales, maintenance commission, maintenance system, etc. and the association thereof with the makers/maintenance companies.

A first trouble dealing method is directed to a case where the primary maintainer deals with the overall trouble dealing work (YES in step S1103), for example, a case where a maintenance company belongs to a group company of makers/vendors and the operating system/service processor/maintenance engineer deals with a trouble of server equipment/incidental facilities equipment of the system which can be handled as in-house products, and a case where the primary maintainer is supplied with all the maintenance techniques/maintenance parts as OME products from his/her maker.

A second trouble dealing method is directed to a case where the primary maintainer does not deal with the overall trouble dealing work (NO in step S1103), but deals with a part of the trouble dealing work (YES in step S1104). For example, the operating system of the multi-vendor system is common, the primary maintainer can handle the operation/judge the trouble condition and collect data such as error logs, etc., and the vendors/makers deal with the maintenance techniques/maintenance part supply/part exchange as the secondary and subsequent maintainers.

A third trouble dealing method is directed to a case where the primary maintainer can carry out little trouble dealing work. That is, when the primary maintainer cannot perform even a part of the trouble dealing work (NO in step S1104), the primary maintainer delivers the trouble dealing work to the secondary and subsequent maintainers (step S1105). For example, this is a case where multi-vendor system equipment operates according to a peculiar operating system or a case where maintenance companies/maintenance departments deal with incidental facilities.

The first, second and third methods of the trouble dealing work will be described with reference to FIGS. 10, 11 and 12.

After the trouble dealing work has been completed, the primary maintainer checks the completion of the trouble dealing work by a test run job or the like (step S1106), checks/operates restart of the operation (step S1107), reports the result of the trouble dealing work, that is, the phenomenon/cause/dealing of the trouble to the user of the multi-vendor system equipment by an electronic mail (step S1108), reports the damage due to the trouble (step S1109) and the recovery condition of the trouble (step S1110) and then completes the trouble dealing work (step S1111). The primary maintainer terminal 709 may be equipped with remote starting means to start the test run job under the remote control from the primary maintainer terminal 709. Various reports are input and created from the primary maintainer terminal 709, and transmitted through the multi-vendor system monitoring and reporting server 15 by electronic mails or the like.

Next, the first trouble dealing method will be described in detail with reference to FIG. 10. FIG. 10 shows an example of the first trouble dealing method out of the three methods into which the trouble dealing work is roughly classified, and shows the method in which the primary maintainer handles the overall dealing work of the troubles (step S1201). The left half side of FIG. 10 is a flowchart of the work carried out by the primary maintainer (step S1202), and the right half side of FIG. 10 is a flowchart of the work carried out by the secondary and subsequent maintainers (step S1203).

As described above, FIG. 10 shows the trouble dealing method (step S1201) when the primary maintainer carries out the overall trouble dealing work, and also it shows that the work of the primary maintainer (step S1202) contains all the trouble dealing steps while the work of the secondary and subsequent maintainers (step S1203) contains no step.

Referring to FIG. 10, the primary maintainer is informed of occurrence of a trouble at the primary maintainer terminal 709, and accepts the occurrence of the trouble. If it is judged on the basis of the operation content of the system server equipment under trouble and the trouble content that the system operation is preferentially continued (YES in step S1205), the primary maintainer carries out the re-start operation (step S1206). The restarting operation contains an automatic restarting operation based on the function of the operating system of the system server equipment.

When the restart succeeds manually or automatically and thus the system operation is continued, the trouble is regarded as an intermittent trouble (YES in step S1207). In this case, priority is given to the continuation of the system operation, and thus the system operation is continued. A machine time for searching for the cause of the trouble and investigating/dealing with the trouble/failure is secured (step S1209), and the system operation is stopped when the operation stop condition is satisfied. In the case where the system operation is preferentially continued (YES in step S1205) and the trouble is an intermittent trouble (YES in step S1207), the trouble dealing work cannot be carried out unless the operation stop condition is satisfied, and thus the trouble analysis based on execution of a test/diagnosis program cannot be immediately carried out, so that only logs which can be collected under operation are collected.

In the case where the system operation is not preferentially continued (NO in step S1205), the system server equipment is once stopped irrespective of the type of the trouble, and a dealing work of finding out the cause of occurrence of the trouble is preferentially carried out. Even when the restart operation is automatically operated, the system operation stopping operation (step S1208) is carried out by the system operation stopping means. When the trouble is not recovered by the automatic/manual restarting operation (step S1206) and when the trouble occurs again in short time after the restart operation is carried out, it is judged that the trouble is not an intermittent trouble (NO in step S1207), but a fixed trouble, and the system operation stopping operation for carrying out the trouble dealing work (step S1208) is carried out.

In the case of the system server equipment having such a function that an automatic trouble report is added with a trouble error log (YES instep S1210) and then transmitted, a maintenance engineer is immediately secured at a technique support department (step S1212) to make log analysis (step S1213), or the primary maintainer itself makes log analysis by itself (step S1213).

When no trouble error log is added to the automatic report (NO in step S1210), trouble error logs are collected by log collecting means (step S1211).

When a trouble site can be specified on the basis of the log analysis result (step S1213) of the log analyzing means (YES in step S1214), a trouble part is ordered by the part ordering means (step S1216).

If the trouble site is not found out (NO in step S1214) a part which is estimated as the cause of the trouble is settled by the trouble event, the error log, etc. (step S1215), and the part is ordered (step S1216).

The new part carried (step S1217) is received, and the trouble part or the trouble-estimated part is exchanged for the part thus received (step S1218).

Furthermore, by using the primary maintainer terminal 709, the progress information of the trouble dealing work such as the trouble dealing condition, the recovery prospect, etc. is created and timely reported to the system manager, the end users, etc. by electronic mails (step S1204).

The number and type of steps of FIGS. 11 and 12 described below are the same as those shown in FIG. 10 described above. That is, the steps S1205 to S1218 are the same as the steps S1305 to S1318 shown in FIG. 11 and the steps S1405 t S1418 shown in FIG. 12 respectively, and they are different in that the location of each step is contained in the work of the primary maintainer (steps S1202, S1302, S1402) or the work of the secondary and subsequent maintainers (steps S1203, S1303, S1403).

The details of the second trouble dealing method will be described with reference to FIG. 11.

FIG. 11 shows a method of carrying out a part of the trouble dealing work by the primary maintainer (step S1301). As the work of the primary maintainer (step S1302), the primary maintainer which grasp the overall system constructed by the multi-vendor equipment mainly operates as a leader the system operation with respect to the trouble dealing work. That is, the primary maintainer carries out the operations relating to the system operation of the system server equipment, that is, the primary maintainer carries out the restart operation (step S1306), the system operation stopping operation (step S1308), the investigation machine time securing stop operation (step S1309) and the error log collecting operation (step S1311). Furthermore, the work of the secondary and subsequent maintainers (step S1303) mainly elucidates the cause of a trouble of hardware and deals with the trouble, collects information on the trouble condition and error logs to grasp the trouble content, and then carries out detailed log analysis on the trouble (step S1313), ordering parts (step S1316), carrying of the parts (step S1317) and exchange of the parts (step S1318).

The primary maintainer timely checks the trouble dealing condition to the secondary and subsequent maintainers, receives the reports of the trouble dealing progress (step S13042), adds the primary-maintainer's condition judgment and reports the progress of the trouble dealing work such as a trouble dealing condition recovery prospect, etc. to the system manager, the end users, etc. by electronic mails or the like (step S13041).

Next, the details of the third trouble dealing method will be described with reference to FIG. 12. FIG. 12 is a method of delivering the trouble dealing work from the primary maintainer to the secondary and subsequent maintainers (step S1401). The work of the primary maintainer (step S1402) is limited to only the window work to the manager of the multi-vendor system equipment and the users, and the work of the secondary and subsequent maintainers (step S1403) covers the operations on the system operation and the works from the log collection/analysis to the part exchange of hardware.

The primary maintainer timely confirms the trouble dealing condition to the secondary and subsequent maintainers, receives the progress report thereof (step S14042), adds the progress report with the primary-maintainer's condition judgment, and timely reports the trouble dealing progress such as the trouble dealing condition, the recovery prospect, etc. to the system manager, the end users, etc. (step S14041).

This is an example of the trouble dealing work of the primary maintainer for the system comprising special equipment and incidental facilities.

The trouble dealing method as described above are roughly classified into three methods. It is assumed that which one of the primary maintainer and the secondary and subsequent maintainers should carry out each step of the trouble dealing work should be carried out is properly determined in accordance with the characteristics of the maintenance system/maintenance technique of the system server equipment/incidental facilities. For example, with respect to the degrade trouble of the array discs, the secondary maintainer carries out only the part supply. That is, the secondary maintainer order for parts (step S1316) and carry the parts (step S1317), and the primary maintainer carries out part exchange (step S1318), etc.

When the log collection (steps S1211, S1311, S1411) is set as trouble dump data collection, the log analysis (steps S1213, S1313, S1413) is set as dump data analysis, the part exchange (steps S1216, S1316, S1416) is set as patch correction target creating request for software defects, the part carrying (steps S1217, S1317, S1417) is set as patch correction target achievement and the part exchange (steps S1218, S1318, S1418) is set as patch correction target application in the step types of the trouble dealing method shown in FIGS. 10, 11 and 12, the trouble dealing method described above is a trouble dealing method for software troubles.

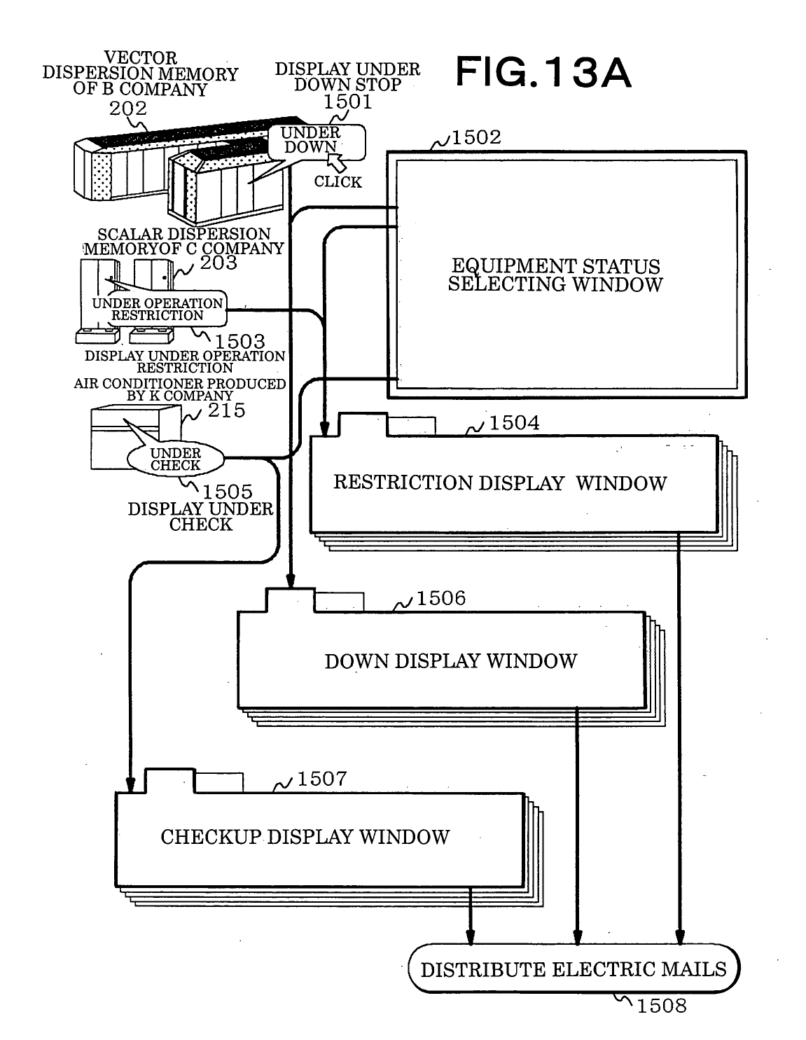

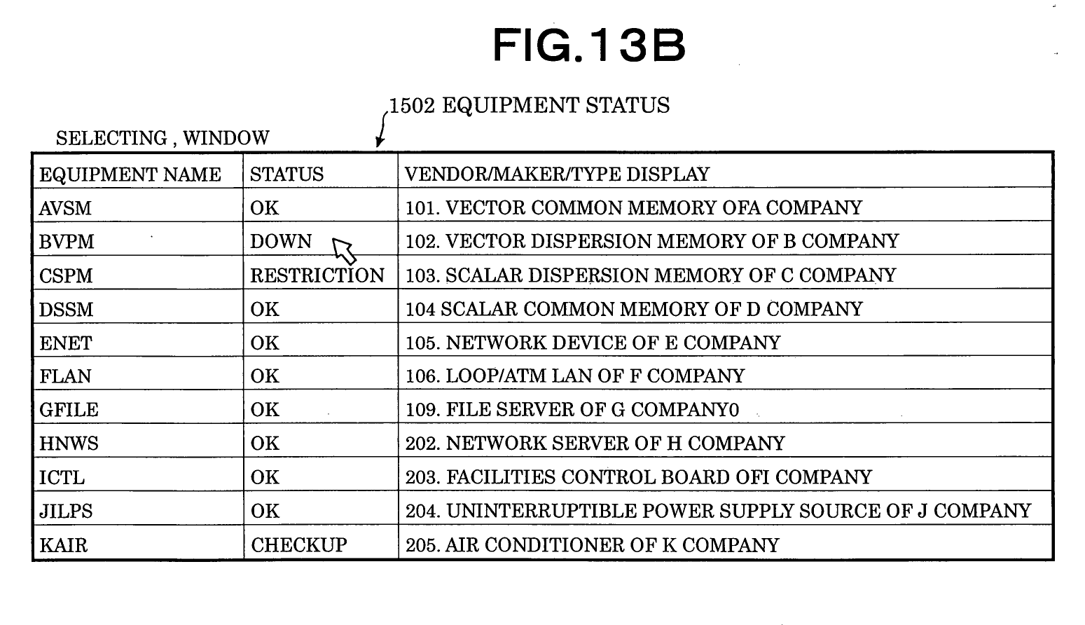

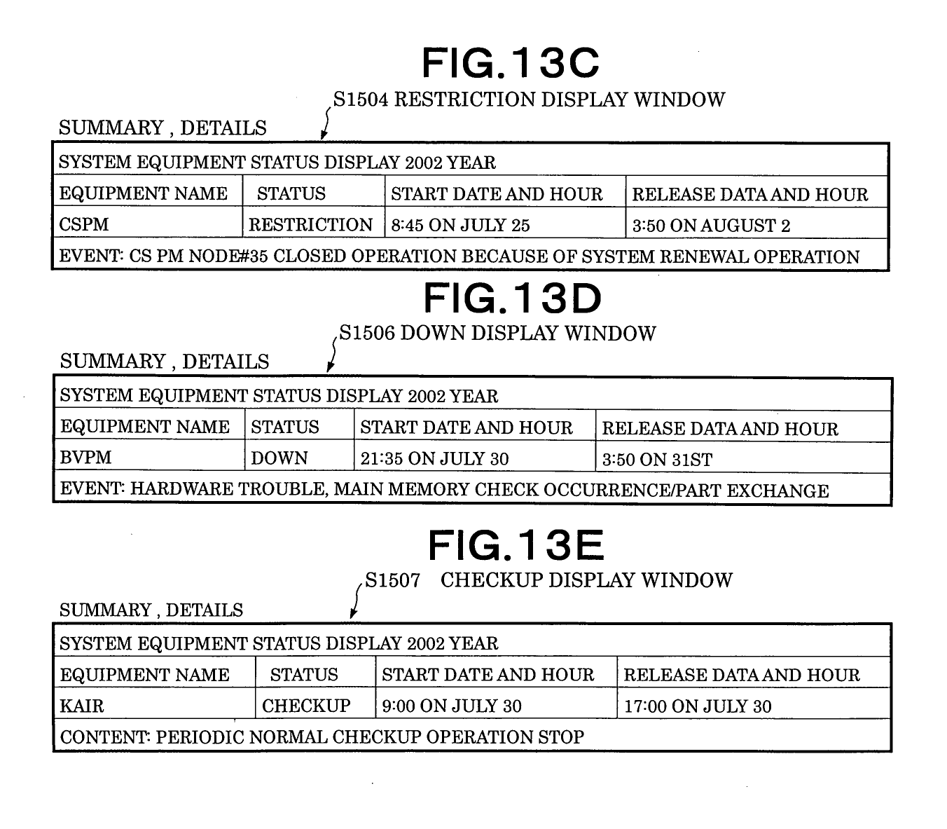

Next, a method of transmitting trouble information to parties concerned through the Internet when the primary maintainer senses, recognizes and accepts troubles of multi-vendor system devices will be described with reference to FIGS. 13A to 13E.

FIGS. 13A to 13E are diagrams showing the method of transmitting the trouble information.

When the primary maintainer senses, recognizes and accepts troubles of multi-vendor system devices through the primary maintainer terminal 709, the primary maintainer creates balloon descriptions for a pictorial diagram of the system structure of the multi-vendor system devices and a list of the statuses of the multi-vendor system devices, and presents the list on the web of the multi-vendor system monitoring and reporting server 15.

Referring to FIGS. 13A to 13E, when a vector dispersion memory machine 202 produced by B company is stopped because a trouble down occurs in the vector dispersion memory machine 202, a down stop display 1501 indicating “under down” with a balloon description is made. Furthermore, when the use of a scalar dispersion memory machine 203 produced by C company is required to be restricted to end users under some operation situation or because of software renewal, an under-restricted-operation display 1503 indicating “under restricted operation” is made with a balloon description. Furthermore, when an air conditioner 205 produced by K company is under check, an under-check display 1505 indicating “under check” is likewise made with a balloon description. The list of the statuses of the multi-vendor system devices is also displayed in a device status selecting window 1502.

As described above, “under trouble down”, “under check”, “under switching to auxiliary system device because of one system device is stopped in a dual-redundant system”, “under partial degeneration of system function”, “under closed use because of some operation situation or software renewal”, “under partial operation-mode restriction”, etc. are presented on the Internet web by using balloon descriptions for a pictorial diagram of the system structure of the multi-vendor system devices or also the summary of instruction contents are informed to interested sites by electronic mails 1508.

A user of a multi-vendor system device accesses a web display to see a trouble condition or the like, and clicks the balloon of the status display by a mouse or clicks the status column of the device status selecting window 1502 by a mouse to check the details.

For example, if the status is a “restriction” status, a restriction display window 1504 is displayed, and “system device status display 2002 year”, device name “CSPM”, status “restriction”, operation restriction “start date and hour”, “release expected date and hour”, restricted matters “CSPM node #35 closed operation for system renewal work” are first displayed as brief display titles. Relating information such as details of restricted content, system operation renewal content, renewal past record, function enforced points through version-up of operating system, system operation defectiveness/improvements to defectives, etc. are displayed by detailed tag selection.

Furthermore, if the status is a “down” status, a down display window 1506 is displayed so that brief display titles, the names of devices, status “down”, “occurrence time” of down, “recovery expected time”, event of trouble “hardware trouble occurrence of main memory check/part exchange dealing work” are likewise displayed. Immediately after the detailed phenomenon, cause, dealing, etc. are made clear, they are displayed by the detailed tag selection, and also the trouble pas record, operation rate, etc. of the device concerned are displayed. Furthermore, damaged jobs and users suffering damages due to the system device down are also displayed, and it is displayed whether the users themselves need recovery work, and the delay status of the overall system operation is displayed.

If the status is a “check” status, a check display window 1507 is displayed so that “start date and hour”, “completion expected date and hour”, check content “operation stop for periodic normal check”, etc. are displayed. An annual check schedule, a guidance for an urgent special check, a guidance for extension of the check completion expected time, etc. are displayed by the detailed tag selection.

At the time point when these display windows are displayed, at the time point when the contents thereof are renewed or at the time point when each of various works is completed, electronic mail distribution 1508 is appropriately carried out to interested sites.

Next, an example of the electronic mail notification/report message at the start/occurrence and completion time of trouble, renewal and check work will be described with reference to FIGS. 14A to 14D.

FIGS. 14A to 14D are diagrams showing an example of distribution messages based on electronic mails, and particularly, FIGS. 14A to 14D show trouble-relating report/distribution messages based on electronic mails, restriction-relating guidance/distribution messages based on electronic mails, check work relating schedule/distribution messages based on electronic mails, and work completion relating notification/distribution messages based on electronic mails.

When a trouble is automatically reported, the trouble relating reporting/distribution messages based on electronic mails contain the following detailed contents for the dealing method for the multi-vendor equipment.

(1) “Trouble reporting is started by BB device of AA company”

It is sensed with an RS signal by the multi-vendor system monitoring and reporting server that automatic reporting based on SVP or automatic reporting modem connected to a communication controller of the system is started. In this case, “by BB device of AA company” is preset in the multi-vendor system monitoring and reporting server on the basis of the position, location of the DTE connector of hardware connected to the DTE cable of the modem, and thus the set value concerned is installed in a message words indicating only start of report for devices which can merely sense the RS signal, that is, “Trouble report is started” is installed in the message. In this case, the content of the trouble message cannot be identified from the reporting device (only the RS signal). Therefore, there occurs such a case that the primary maintainer is needed to search a trouble mail from the automatic monitoring and reporting server which is based on a console message of the device under trouble, or manually inputs a command and searches console logs and the internal construction information of the server itself, thereby investigating the contents thereof.

(2) “Memory trouble occurs in DD device of CC company”

In this case, the communication protocol of the reporting based on SVP or the like can be communicated between multi-vendor system monitoring and reporting servers, and the message of the trouble reporting may be constructed by editing the content of the automatic report data.

(3) “Critical trouble occurs in uninterruptible power supply source FF of EE company”

The multi-vendor system monitoring and reporting server receives the trouble of the uninterruptible power supply source (USP) as a contact point signal, the fact “Critical trouble occur in the uninterruptible power supply source FF of EE company” is recognized on the basis of the position, number of the contact point signal connection terminal, and then the message thereof is distributed. At this time, the critical trouble of UPS automatically switches the function of UPS to a bypass operation. Therefore, if this switching operation succeeds, the contact point corresponding to the success is input to the multi-vendor monitoring and reporting server. In response to the input of the contact point signal concerned, the multi-vendor system monitoring and reporting server distributes a message “commercial power bypass operation is started because of the trouble of the VV uninterruptible power supply source” in the restriction-relating item (8) described later

(4) “Temperature upper limit alarm in GG room is sensed”

In this case, the temperature of a machine room is increased, and an indoor temperature condition detecting and alarming sensor is actuated. A trouble notification destination is automatically reported to a cellular phone of (a person) a department in charge of air-conditioning facilities in the machine room in its station, or a maintenance company in charge of the air conditioning facilities (a cellular phone of a secondary maintainer), or a report mail is distributed thereto.

(5) “No response from II server of HH company”

This message is a report message in a case where a trouble is detected by health check through LAN or the like of the multi-vendor system monitoring and reporting server when the device concerned has no automatic reporting function or the reporting function cannot be operated or does not work because the system is under stall state. In this case, the stall of the server cannot normally detect the stall state unless the system user access the server. Therefore, the multi-vendor system monitoring and reporting server judges at a fixed time period on the basis of presence or absence of a response to a remote command whether the server is living (health check). If there is no response, the trouble reporting is carried out. Before a notification from the server use, the maintainer and the manager can recognize the trouble.

(6) “KK array disc device of JJ company is degenerated”

This is detected by the SVP function or the function of the operating system, and normally it does not disturb the system operation. Therefore, in this case, report messages for the ordering of parts (disc unit) and a request for achieving (carrying) the parts are simultaneously distributed to the maintenance center of the primary maintainer and the vendor/maker (secondary maintainer).

(7) Air conditioner trouble occurs in MM machine of LL company”

Since the trouble is an air conditioner trouble, the multi-vendor system monitoring and reporting server accepts the contact point signal of the trouble and reports the trouble. This is the same as the item (4). When the number of the air conditioners is equal to 1, there may be provided an automatic operation function of automatically shutting down the system when increase of the room temperature is sensed executing various operations until the device is powered off.

(8) “Instantaneous electric power outage has occurred just now. Please inform effects to machines”

The event that the instantaneous electric power outage occurs can be known by the multi-vendor system monitoring and reporting server on the basis of the contact point signal. This is a reporting mail to check damages to terminals such as devices which are not connected through UPS (that is, directly connected to the commercial power supply) air conditioners in the machine room, outdoor units of the air conditioners, work stations, etc. An automatic operation function for automatic shut-down stop of the system may be equipped in consideration of a situation that the outage is prolonged and thus the battery is consumed.

The following detailed contents of the trouble dealing method for the multi-vendor equipment are provided as the restriction-relating guidance/distribution messages based on electronic mails.

(1)“CSPM node #35 Unusable because of system renewal work”

This message is a reporting mail when only some of plural setup dispersion type operation servers, one device (node) is operated for stop of use of end users (it is unnecessary to stop all the nodes), that is, when an input job queue of a single node is renewed, the maximum value used for a file is renewed or the like. That is, this case corresponds to such a case that for the purpose of promotion of use of the dispersion type operating servers and efficient use, the operation is stopped for the renewal work under the recommendation of the system manager or the primary maintainer.

(2) “You cannot communicate with the external because of network renewal work”

Information is reported collectively in its station, in the same network and on the same premises.

(3) “NN server device is temporarily unusable because of renewal”

The case corresponds to such a case the system manager and the primary maintainer have a meeting to make a guidance for stop because of a renewal work of equipment.

(4) “Please log-in via QQ server because of PP server

This is a guidance when only one system is operated in the dual-redundant system.

(5) “RR file overflow occurs, and please delete unnecessary files for SS operation”

This guidance is made by sensing a console message of a server in the multi-vendor system monitoring and reporting server or on the basis of detection based on the operator call function of the operating system of the server.

(6) “Don't execute editor to large-capacity file by TT server”

In the case where plural various kinds of servers are combined to construct a multi-vendor system, there occurs such a case that the use method of each server is restricted according to the system operation method. Therefore, the primary maintainer finds out a user who does not know use restriction to servers on the system operation or a user who executes a job with neglecting the use restriction, and gives a warning to these users.

(7) “Access abnormality to UU server has been recovered by rebooting device”

The description will be made on the assumption that UU server is a file server. When accessing a partial range (domain) of a file owned by the file server by an operating server, a data input/output error occurs due to, not a hardware trouble of a disc unit, but logical injustice of the file (software management directory disturbance), and an I/O error message is output to the console of the file server device. The multi-vendor system monitoring and reporting server senses this I/O error message, and automatically reports or distributes trouble reporting mails to the primary maintainer and the system manager. The primary maintainer and the system manager carries out the operations of stopping the operation of the operating server and completely stopping the access to the file server. At the same time, the secondary maintainer is also reported, collects the data of the error status by a remote access and grasp the contents of the data. The primary maintainer judges the error status, and reboots (restarts) the file server device by inputting a command from the console, whereby the access abnormality to the file server is recovered.

(8) “Commercial power bypass operation is started because trouble occurs in VV uninterruptible power supply source”.

See the trouble-relating item (3) described above.

With respect to the check work relating schedule/distribution messages based on electronic mails, the following is provided as the detailed contents of the trouble dealing method for multi-vendor equipment.

(1) “Periodic checkup stop: Periodic checkup of WW month is XX day (Y-day of the week)”

The primary maintainer makes a discussion about the contents of the maintenance checkup work for server devices and facilities constituting a multi-vendor system, and distributes this message under the acknowledgement of the system manager.

(2) “Trouble occurs under periodic checkup, and check completion time is extended by two hours”

The primary maintainer grasps and monitors the working status under the system periodic checkup (under scheduled stop operation), and distributes this message if the actual completion time is estimated to exceed the check completion schedule time.

(3) “Please check NFS function after check of ZZ file server has been completed”

The primary maintainer grasps the function of each server and the working content, and distributes this message when he/she judges that the workers of the respective servers are required to carry out final check operation in addition to the normal check work on the whole. This message is a guidance for requesting the respective operating servers to check whether the mount of the network file, etc. operate normally and restart the operation because the file server is renewed.

(4) “special check: System operation will be extraordinarily stopped this Saturday to improve hardware”

When there occurs a special maintenance work which cannot be completed within a normal periodic checkup work time, the primary maintainer have a discussion with vendors/makers and distributes this message under the acknowledgement of the system manager.

(5) “New queuing is suppressed for periodic checkup stop to keep all the jobs finished”

When a job being executed cannot be interrupted or a patch correction work occurs at the time when the periodic checkup work is completed, the primary maintainer sets all the jobs being executed before the check work to the execution-completed state. That is, it carries out the operation and distributes a guidance to complete all the jobs and make the jobs empty.

(6) “Correction patch is applied to defect of bb server under today's check work”

The primary maintainer grasps and manages defects by himself/herself or with the assist of the secondary maintainer, and suppresses occurrence of trouble by operation restriction, etc. The primary maintainer checks whether the trouble is completely solved and also there is any problem when viewed from the overall system side, and after the primary maintainer confirms that no secondary trouble occurs due to the patch correction, the primary maintainer distributes this message. Furthermore, it is checked whether the correction is proper or not for users suffering some damage.

(7) “Advance notice of power outage for all the facilities of the overall system: Daylong power outage on dd day of cc month because of check of electric facilities”

The primary maintainer achieves information on scheduled power outage from the manager and the departments of the facilities, and distributes a guidance of power outage mainly to the vendors/makers to grasp points to keep in mind and restriction matters at the power outage time, grasp points to be done at the power recovery time and reduce troubles.

(8) “Distribution board work is executed on periodic checkup date. Power supply of ee room system is cut off”

The primary maintainer grasps the wire paths of power supply facilities of building, machine room, manages the facilities renewal past records and distributes a guidance of an influence range at the partial power outage time.

With respect to work-completion relating notification/distribution messages based on electronic mails, the following is provided as the detailed contents of the trouble dealing method for the multi-vendor equipment.

(1) “Trouble of BB device of AA company has been recovered”

The primary maintainer not only merely receives the report of the trouble repair, but also distributes this message after it is checked that there is no problem in the overall system, that is, after complete check for the trouble maintenance/repair is carried out on trial user jobs, load running jobs, it is confirmed that there is no secondary trouble due to the maintenance work and then the system operation is started.

(2) “Trouble dealing work of memory trouble occurrence in DD device of CC company has been completed, and system operation is restarted”

The same matter as (1) is satisfied. In addition, the primary maintainer manages the trouble past records of all the multi-vendor equipment, and grasp the records as case examples.

(3) “Repair of critical trouble in uninterruptible power supply source FF of EE company has been completed”

The same matter as (1) is satisfied. In addition, the primary maintainer manages the battery (consumption) exchange past record of the UPS device and grasps the battery exchange due date to promote the battery exchange.

(4) “Permanent dealing with error output case in ff system has been completed today”

The primary maintainer grasps and manages defects such as bug, etc. by himself/herself or with the assist of the secondary maintainer to suppress occurrence of troubles by operation restriction or the like, and under such circumstances, the primary maintainer distributes this message to indicate that the trouble concerned has been completed solved.

(5) “Periodic checkup has been completed as scheduled, and the system operation is restarted to hh:mm”

The primary maintainer not only transmits the completion of the check merely, but also distributes this message to indicate that he/she checks the overall operation of the system after receiving a check completion report from each vendor/maker (secondary maintainer) by mail or the like, and the system operation is restarted, that is, the users are allowed to log in.

(6) “ii file is being recovered in gg system, and please wait for a moment”

When the trouble recovery work needs long time or the trouble recovery work must be continued for a longer time than estimated, the primary maintainer time distributes the progress information of the trouble recovery work.

(7) “Three batch jobs are restarted due to ii system down”

The primary has the system operation method and means for grasping jobs being executed at the system down time and re-executing damaged jobs without making users unnecessary to restart the damaged jobs at the system operation restart time and also with eliminating cumbersome labor from the users, and distributes the names of jobs to be restarted due to system down.

(8) “Repayment of charges of restart jobs has been completed”

The primary maintainer grasps jobs being executed at the system down time, repays the loss of the charge until the system operation is started from the system down time, and distributes the repayment information to the system manager and the users.

The primary maintainer judges the information relating to the trouble maintenance services on the basis of instructions from and discussions with the system manager or by himself/herself, grasps the trouble work condition from the secondary maintainer, collects information, and carries out creation of display contents shown in FIGS. 13A to 13E and 14A to 14D and the mail distribution from the primary maintainer terminal 709.

Next, a method of reporting the matters relating to the maintenance services will be described with reference to FIGS. 15 to 18.

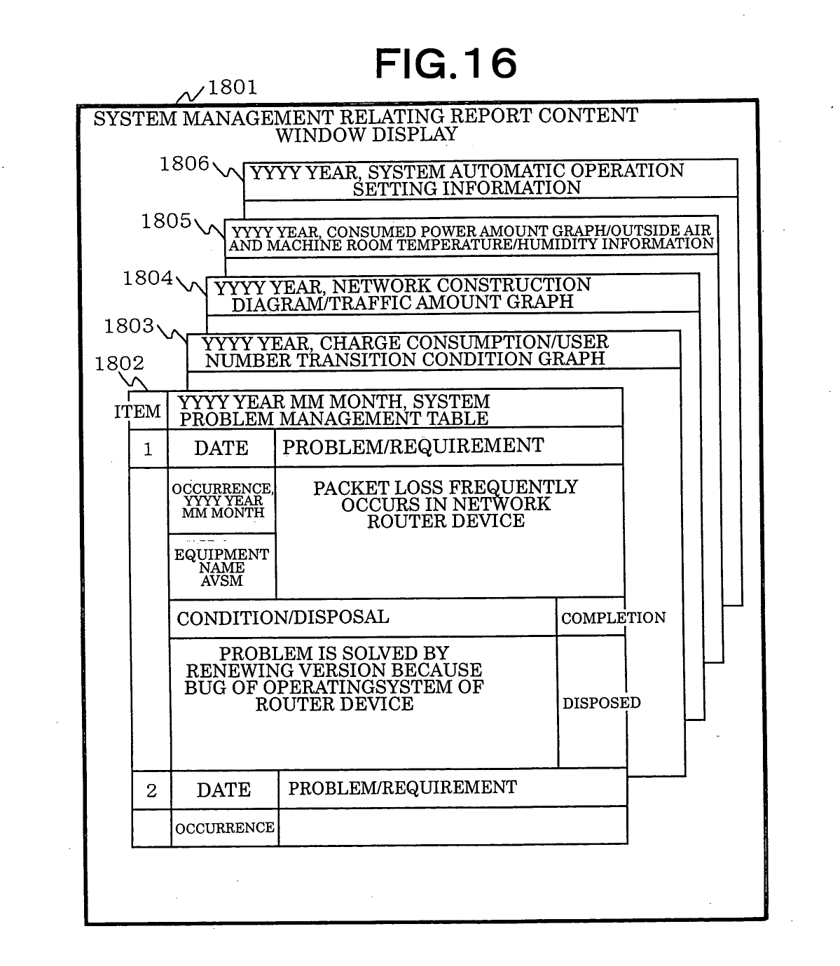

FIG. 15 is a diagram showing a display example of a report content window relating to the system operation, and FIG. 16 is a diagram showing a display example of a report content window relating to the system management. FIGS. 15 and 16 show an example of a format to report the content as a monthly report.

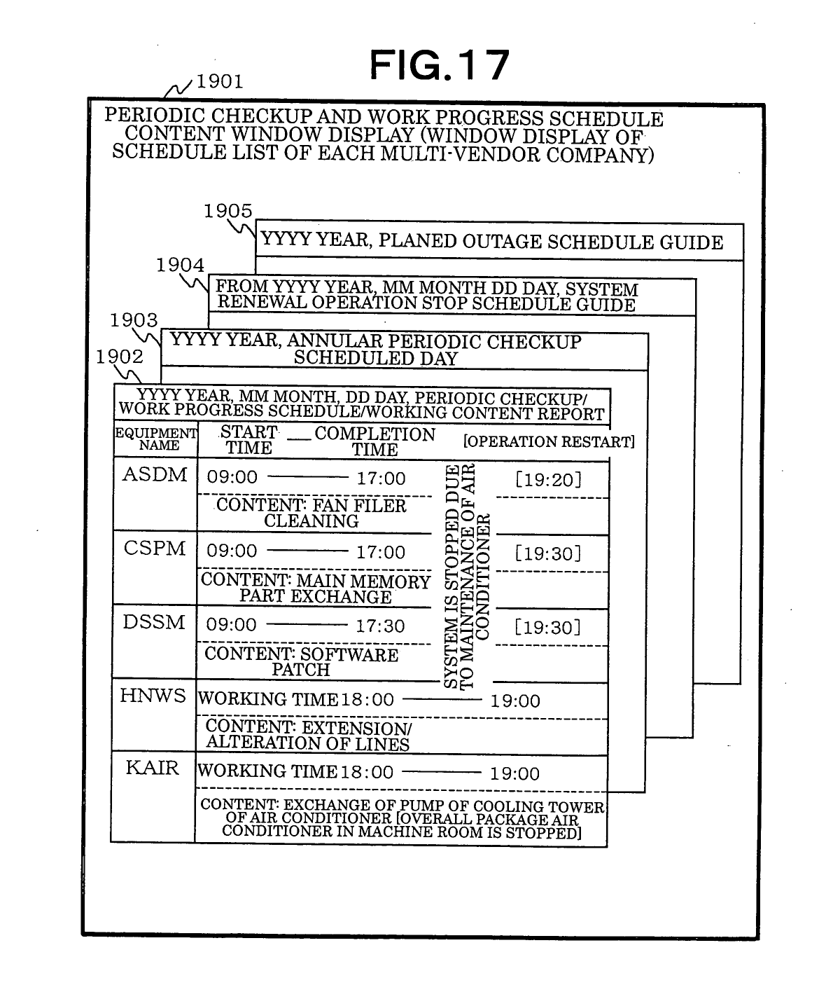

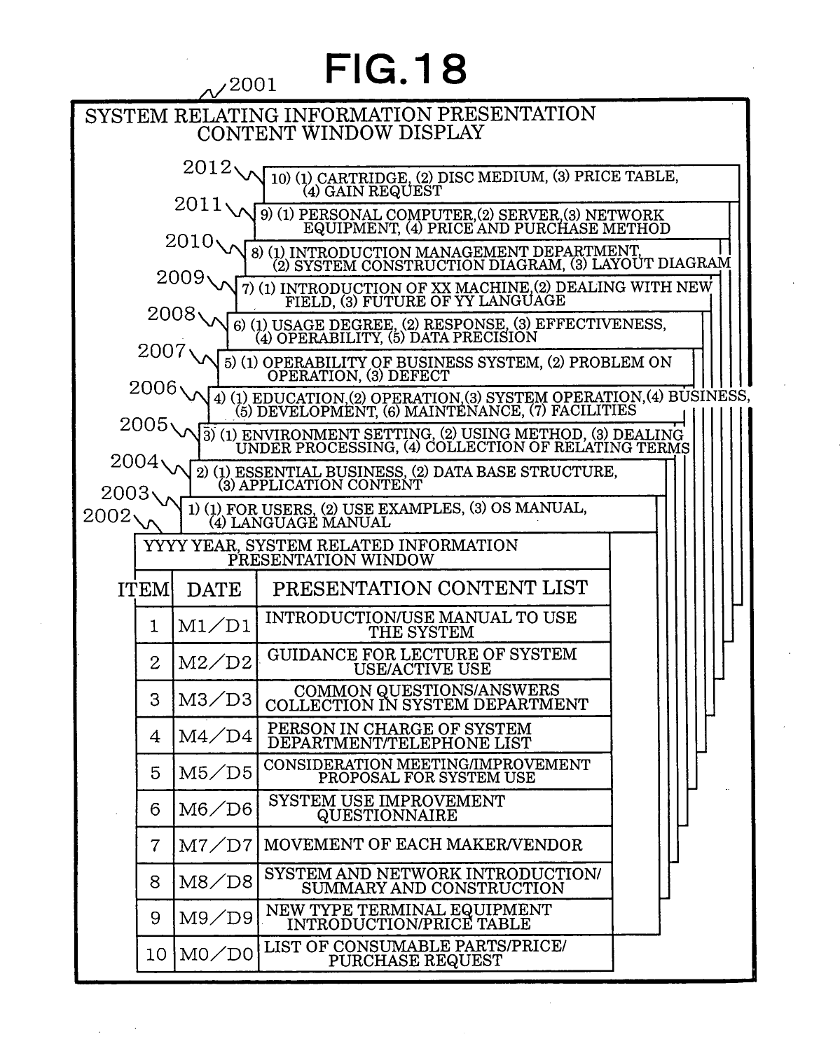

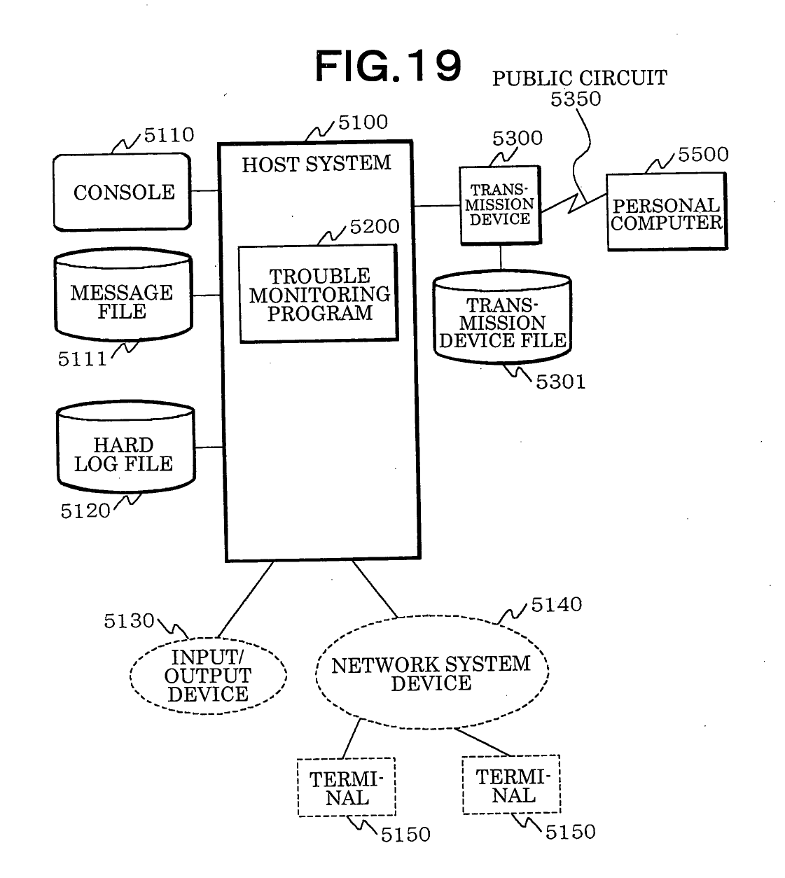

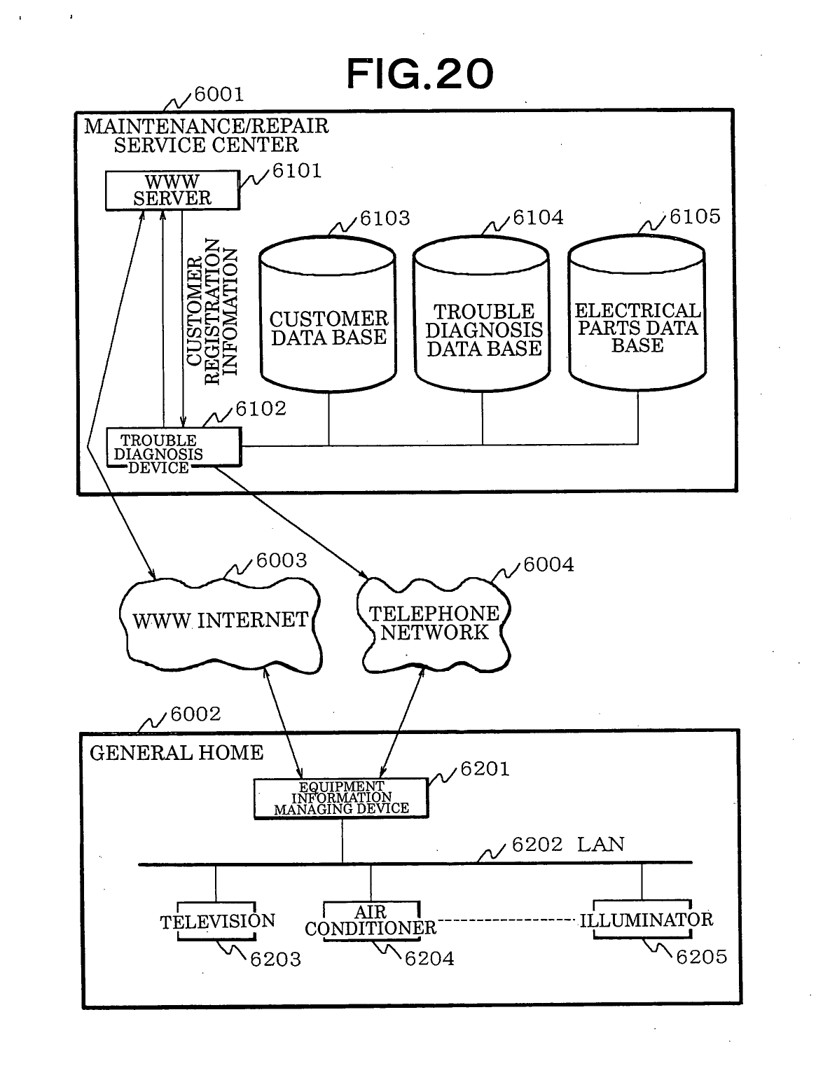

FIG. 17 is a diagram showing an example of a periodic checkup and working process schedule (an example of a schedule list of each of the multi-vendors). FIG. 17 also shows an example in which the primary maintainer grasps and harmonizes the working content/manpower/resource condition of each multi-vendor company, and these data are displayed as a future plane/schedule. FIG. 18 is a diagram showing an example of the information display content relating to the system.

The primary maintainer collects information by himself/herself and collects information from the secondary and subsequent maintainers, creates the summary of matters relating to the maintenance service by using the primary maintainer terminal 709, presents these data on the web of the multi-vendor system monitoring and reporting server 15, or distributes these data to the system manager and the end users through the multi-vendor system monitoring and reporting server 15.

Referring to FIG. 15, a system operating time list, a CPU/MEMORY/FILE usage rate graph, a system job number/queuing graph and a system trouble number/trouble rate graph are shown as report content window displays relating to the system operation.

Here, the power supply time of the system operating time list is defined as the actual time of MM month of YYYY year. That is, it is assumed that the mm month is 31st day. 24-hour continuous operation has recently prevailed, and thus the operation time when the 24-hour continuous operation is carried for one month is equal to 24 hours×31 days=744 hours. Therefore, the power supply time (actual time) of the system operating time list is achieved by subtracting from 744 hours the time for which the power supply to the system equipment is totally stopped due to check/renewal of the power supply facilities, that is, the outage for one month. Furthermore, the operating time is achieved by subtracting from the power supply time a periodic checkup/urgent check time and a trouble time, that is, a time for which the system is stopped due to a hardware trouble and software defect. The operating time is set as a time for which the system operation can be performed, and the operation/usage rate is calculated on the basis of the operating time.

With respect to the CPU/MEMORY/FILE usage rate graph, the CPU-relating graph indicates the ratio between the system operable time and the running time of CPU-relating equipment, and the MEMORY-relating graph indicates the ratio between all the kinds of the MEMORY capacities of the whole mounted system equipment and the capacity used by job running.

For example, in the UNIX™ operating system, the system job number/queuing graph indicates the number of jobs of the overall system, the number of jobs every job queue type, etc., and it is an execution queuing graph in each job queue class.

The system trouble number/trouble rate graph indicates the number of trouble-relating cases and the trouble rate every system type or every system.

Referring to FIG. 16, as report window displays associated with the system management are displayed a system problem management table, a charge consumption/user number transition condition graph, a network construction diagram/traffic amount graph, a consumption power amount graph/outside air and machine room temperature/humidity information and system automatic operation setting information.

The system problem management table manages and displays problem points of the overall system irrespective of hardware/software, and it is especially important to display pending problems and unsolved problems. For example, hardware intermittent troubles, hardware cause unclear troubles, problem points of bugs of firmware and software are displayed, and it is displayed to each multi-vendor company whether the problem solution and the dealing work should be carried out or were carried out for requirements for altering the system specification, renewing customizing, improving and altering performance, etc. As an example of the format of the system problem management table are displayed problem/requirement matter occurring year/month/day, the names of devices and problem point/requirement “packet loss occurs in network router device”, condition/dealing “problem is solved by renewing version because the problem is caused by bug of operating system of router device”, the problem point has been solved, and “trouble has been dealt”.

The charge consumption/user number transition condition graph indicates the effective use of the system resource such as the file capacity, etc. by the charge consumption condition and the transition of the system users in addition to estimated data such as fair use, justice use, preferential use, etc. to the system users.

The network construction diagram/traffic amount graph shows particularly the construction of the network equipment in the system equipment construction, makes it easy to grasp the overall network, shows the troubles of the network equipment itself, the troubles of the communication lines and the job load of the overall system. In addition, it shows the capacity of the network file system between the respective servers, a proper access condition of the file system and the load condition of the file system, and also shows them to sense an unreasonable network file access use condition.

The consumption power graph/outside air and machine room temperature/humidity information shows the operating status and load status of the system equipment. Since the power consumption is greatly varied in accordance with the type of LSI elements used in the system equipment, the judgment condition for the renewal time of the system equipment can be known for economical operation. Particularly, the consumption power relating to the air conditioners is greatly varied in accordance with the weather and the outside air temperature, so that the temperature/humidity information of the outside air and the machine room are displayed to enable supplement of quantity of electricity/electricity charges.

The system automatic operation setting information contains unmanned automatic operation information based on an automatic operation processing device of system equipment which is set up at present or will be set up in the future. As an operation mode when an operator or a person in charge of system management is absent, that is, as an operation mode under a unmanned state is displayed such information that the system is automatically stopped from XX o'clock to YY o'clock on ZZ day, or security lock is applied under unmanned state and an illegal intruder is detected, that the system is automatically shut down when a user logging in a terminal device is absent or all the batch jobs are finished or the like. That is, information for efficient operation of unmanned power-saving function of the system operation is displayed.

Referring to FIG. 17, as the periodic checkup and working progress schedule content window (a schedule list window display of each multi-vendor company) are displayed a periodic checkup/working progress schedule/working content report, an annual periodic checkup schedule date, a system renewal operation stop schedule guidance, and a planed outage schedule guidance.

The periodic checkup/job working progress schedule/working content report indicates a progress content achieved as follows. That is, in order to carry out the periodic checkup work of system equipment which will be executed in the future, the primary maintainer meets workers of respective associated vendors to have discussions to determine the progress content so that the periodic checkup/working progresses efficiently by adjusting e working time and a working time period and the stop time of incidental facilities is minimized while maximum attention is paid to the convenience of users. As an example of the periodic checkup is indicated the following schedule: the periodic checkup of system equipment whose equipment name is ASDM is executed between 9:00 and 17:00 on a scheduled stop date of the system equipment while the main working content is a cleaning work of a fan filter, the periodic checkup of CSPM (equipment name) is executed between 9:00 and 17:00 while the main working content is a part exchange work of a main memory because of hardware bug or intermittent trouble estimated part exchange, the period check of DSSM (equipment name) is executed between 9:00 and 17:30 while the main working content is a software maintenance work, that is, a software batch renewal work of the operating system. As an example of the working content is indicated the following schedule: the system operation is wholly stopped in connection with the periodic checkup, and a line extending/altering work of HNWS (equipment name) serving as network equipment and a pump exchange work of an outdoor cooling tower serving as air conditioning equipment in a machine room are kept on standby until the periodic checkup is completed, and then the above works are carried out between 18:00 and 19:00. Since the system equipment is wholly stopped for the work of the air conditioning equipment, and thus “system is stopped because of maintenance checkup of air conditioner” and “package air conditioner in machine room is wholly stopped” are indicated as guidance/warning to users. The primary maintainer transmits a confirmation of work start, a confirmation of work progress, a report of work completion report and a system operation restart time to the system manager and the users by electric mails and Internet Webs as in the case of the trouble dealing work of the system equipment in the periodic checkup and the works. Particularly, when the work exceeds a scheduled time in the periodic checkup or the work because of a trouble of system equipment, defect of a checkup exchange part, defect of a batch file or the like, this fact is transmitted and reported in the same procedure as the trouble dealing flow by mails and the Internet.

With respect to the annual periodic checkup schedule day, the schedule days of one year on which the periodic check is carried out are determined by the primary maintainer, and displayed as information for a parts ordering schedule for hardware maintenance of each multi-vendor company and data file/medium for software maintenance. Furthermore, information such as the date and hour of the stop of the system operation which should be transmitted to the users of the system equipment early is displayed.

The system renewal operation stop process guidance indicates a renewal work of system equipment, that is, the set up of novel equipment and local adjustment work, a replacement work to an upper class model, an extending work of peripheral equipment, etc. with respect to hardware, and a version-up work of the operating system with respect to software. That is, schedule information and work process information necessary for the manager and the users are indicated in advance so as to grasp that the operation of system equipment will be stopped for a long term.

The planed outage schedule guidance indicates the date and hour of power outage for a statutory checkup for electric facilities, alteration of electric facilities and a renewal work. That is, it is guided that the equipment stop work is needed over all the work station equipment and terminal equipment of the manager and the users, and it is indicated whether each vendor company is required to deal with the outage stop work.

With resect to the information shown in FIG. 17, the primary maintainer analyzes and edits information by making discussions and inquiries with the respective vendors, etc. through electronic mails or the like and also information supplied from the respective vendors, etc. by using various kinds of tools (schedule software, etc.) of the primary maintainer terminal 709, thereby creating the information shown in FIG. 17. Furthermore, the primary maintainer transmits the information thus created via the multi-vendor system monitoring and reporting server 15 to the system manager and the end users by mail distribution or on-web presentation.

Referring to FIG. 18, the following is indicated as the information display content window displays relating to the system.

Ten items are displayed as item examples of content item/display content list on the system-relating information display window.

A first item relates to “manual of use of system/use manual”, and materials 1) such as (1) for users, (2) use examples, (3) OS manual, (4) language manual, etc. are displayed as detailed items.

A second item relates to “system use/guidance for active use of lecture”, and materials 2) such as (1) base business, (2) data base structure, (3) lecture guidance for application content, etc. are displayed as the detailed items.

A third item relates to “collection of frequent questions/answers in system department”, and materials 3) such as (1) environment setting, (2) use method, (3) dealing under processing, (4) collection of questions/answers for relating terms, etc. are displayed as detailed items.

A fourth item relates to “person in charge in system department/telephone and mail list”, and materials 4) such as (1) education, (2) operation, (3) system operation, (4) business, (5) development, (6)maintenance, (7) persons in charge in respective departments of facilities/telephone and mail list, etc. are displayed as detailed items.

A fifth item relates to “system use consideration meeting/improvement proposal”, and materials 5) such as (1) business system operability, (2) problems on operation, (3) consideration result for defects/improvement request, etc. are displayed as detailed items.

A sixth item relates to “system use improvement questionnaire”, and materials 6) such as (1) use degree, (2) response, (3) effectiveness, (4) operability, (5) questionnaire answer input screen, input request and collection result to data precision, etc. are displayed as detailed items.

A seventh item relates to “movement of each maker/vendor”, and materials 7) such as (1) X-machine introduction, (2) efforts against new field, (3) future of YY language, etc. are displayed as detailed items.

An eighth item relates to “introduction of system and network/summary and construction”, and materials 8) such as (1) introduction of management department, (2) system architecture diagram, (3) layout diagram, etc. are displayed as detailed items.

A ninth item relates to “introduction of new model of terminal equipment/price table”, and materials 9) such as (1) personal computer, (2) server, (3) network equipment, (4) price and purchasing method, etc. are displayed as detailed items.

A tenth item relates “list of consumable goods/price/purchase request”, and materials 10) such as (1) cartridge, (2) disc medium, (3) price table, (4) identification as to which equipment corresponds to consumable goods for which gain request is made, etc. are displayed as detailed items.

The primary uses the primary maintainer terminal 709 to create the information shown in FIG. 18 on the basis of information collected by Internet Web search, magazines, etc. and information supplied from each vendor by electronic mail or the like, and presents the information concerned on the Web of the multi-vendor system monitoring and reporting server 15 or the like. That is, this information aims to satisfy requirements of the manager/users and accommodate the manager/users. Furthermore, the primary maintainer may be allowed to do an agency operation for purchase of manuals, purchase of consumable goods, etc.

As not shown, the devices constituting the multi-vendor system are displayed. In this case, the photographs of the multi-vendor system devices and the summary of the functions thereof may be displayed as specific picture (video) information, and the primary maintainer may work to guide visitors on tour to the machine room. Accordingly, in addition to the effective use of each equipment, such a labor that the system manager must explain the system construction to users and also make a guidance to visitors on tour can be reduced from the system manager, and also the actual use of the multi-vendor system can be presented.

In the above-described embodiment of the present invention, the program, etc. to perform the dealing work of the maintenance service system, etc. are recorded as data in a recording medium (not shown) such as a magnetic disc, an optical disc or the like of a computer, and the data thus recorded are read out by operating the maintenance service system. As described above, the functions of the maintenance service system can be implemented by recording the data for operating the maintenance service system of the present invention in the recording medium and then installing the recording medium.

As described above, the primary maintainer serves as a primary maintainer of the multi-vendor system to control all the maintenance matters as a maintenance window, monitors troubles occurring in devices constituting the multi-vendor system by using the multi-vendor system monitoring and reporting servers and the primary maintainer terminal, reports occurrence conditions of the troubles and solving conditions, creates the system operation information and the system management information and transmits the information to the system manager, end users, vendors, etc., and carry out the normal operation if the troubles of the multi-vendor system are solved. As a result, the system manager can concentrate on the original system management operation separately from the trouble dealing work.

The multi-vendor system according to the present invention as described above has the following effects.

A first effect is as follows. When a trouble occurs in some specific single device constituting the multi-vendor system, the operation of the overall system is stopped by the trouble of the specific single device. In this case, the damage and effect of the stop of the overall system operation on the overall system can be quickly grasped, and the communications to many end users and announcement of instructions can be immediately performed through a network.

The reason for this is as follows. That is, for the purpose of the trouble monitoring and the trouble dealing service for the information processing system constructed by the multi-vendors, the multi-vendor system monitoring and reporting server is added as a constituent element of the system, so that the trouble monitoring can be performed for not only the information processing system equipment, but also the incidental facilities at the set up places of the information processing system equipment by the interface conversion device of the multi-vendor system monitoring and reporting server, and the various kinds of trouble information in the multi-vendor construction can be recognized and then reported to the end users, etc. by the trouble automatic reporting device or trouble mail server of the multi-vendor system monitoring and reporting server.

A second effect resides in that the system manager can grasp the abnormality state of the system early, and the maintenance worker can grasp the trouble condition to quickly make an initial instruction and take an action to deal with the trouble.

The reason for this is as follows. That is, by providing the multi-vendor system monitoring and reporting server, the troubles of the respective devices constituting the multi-vendor system are detected by the interface conversion device of the multi-vendor system monitoring and reporting server, and the troubles thus detected are reported to the system manager, maintainers, etc. by the trouble automatic reporting device or trouble mail server of the multi-vendor system monitoring and reporting server, so that the primary maintainer, etc. can also recognize the troubles of the incidental facilities, etc.

A fourth effect resides in that the system manager can concentrate on the original work while separated from the cumbersome dealing work for vendors, makers, etc. with respect to the management of the operation, maintenance and trouble of the multi-vendor system.

The reason for this is as follows. That is, the primary maintainer terminal is provided, and the primary maintainer makes adjustments and discussions with the vendors of the respective devices of the multi-vendor system about the operation, maintenance and trouble of the multi-vendor system by using the primary maintainer terminal, so that the primary maintainer can serve as a primary maintainer to control the overall maintenance matters as a maintenance window.

A fifth effect resides in that the primary maintainer is provided as a primary dealing party so that plural trouble windows are unified into one window to thereby enhance the efficiency of the maintenance work.

The reason for this is as follows. The primary maintainer grasps the maintenance condition of the overall system, temporarily avoids abnormality and collects error logs, so that the primary maintainer can manage and instruct the working process of the periodic checkup of hardware and software maintenance.

A sixth effect resides in that the maintenance service quality can be enhanced and the degree of satisfaction of customers can be enhanced.

The reason for this is as follows. The latest information relating to the information processing industry can be supplied and both the purchase agency business of information equipment and the purchase business of supply goods can be guided by using the monitoring and reporting function of the multi-vendor system monitoring and reporting server, so that the multi-vendor system of this invention can be actively used for the information supply business and the sales agency business.

1. A maintenance service system for carrying out maintenance service on a multi-vendor system, comprising:
a multi-vendor system which is constructed by various types of equipments supplied from plural vendors and carries out information processing;
a multi-vendor system monitoring and reporting server which is connected to said multi-vendor system, detects a trouble in the multi-vendor system and reports trouble information;
a primary maintainer terminal which is managed and operated by a primary maintainer, receives the trouble information reported from said multi-vendor system monitoring and reporting server, instructs a trouble solving dealing to a maintenance company system associated with the trouble, and creates and transmits a report document relating to a trouble occurrence condition and a trouble solving condition; and
the maintenance company system for receiving the trouble information reported from said multi-vendor system monitoring and reporting server to do maintenance of said equipments constituting said multi-vendor system.

2. The maintenance service system according to claim 1, wherein
said multi-vendor system monitoring and reporting server comprises
an interface conversion device for receiving a trouble automatic reporting message or automatic reporting signal output from each of said various types of equipments and converting the message or signal thus received to a trouble message,
an RS signal sensing portion for sensing an RS transmission request signal and transmitting the signal to said interface conversion device,
a trouble automatic reporting device for reporting the trouble message, and
a trouble mail server.

3. The maintenance service system according to claim 2, wherein
said various types of equipments comprise server equipment, client equipment and incidental equipment.

4. The maintenance service system according to claim 3, wherein
said server equipment has a SVP (service processor), and said SVP has means for detecting a trouble and notifying the trouble to said interface conversion device and said maintenance company system through a modem.

5. The maintenance service system according to claim 3, wherein
said server equipment has a SVP (service processor) and designed so that a DTE cable serving as a interface cable between the SVP and a modem is connected between the SVP and modem while relayed at said RS signal sensing portion,
said SVP has means for detecting a trouble and notifying the trouble to said maintenance company system through the modem, and
said interface conversion device senses through the RS signal sensing portion an RS transmission request signal out of a DTE interface signal to the modem which is transmitted out to the DTE cable, thereby recognizing occurrence of the trouble.

6. The maintenance service system according to claim 3, wherein
the server equipment has means for detecting a trouble through an operating system and notifying the trouble through a modem to said interface conversion device and said maintenance company system.

7. The maintenance service system according to claim 3, wherein
said server equipment is designed so that a DTE cable serving as an interface cable between a SVP (service processor) and a modem is connected between the SVP and the modem while relayed through the RS signal sensing portion,
said server equipment has means for detecting a trouble and notifying the trouble through the modem to said maintenance company system, and
said interface conversion device senses through the RS signal sensing portion an RS transmission request signal out of a DTE interface signal to the modem which is transmitted out to the DTE cable, thereby recognizing occurrence of the trouble.

8. The maintenance service system according to claim 3, wherein
said server equipment has means for detecting a trouble and notifying a message to said interface conversion device with an RS232C serial interface signal.

9. The maintenance service system according to claim 3, wherein
said incidental equipment has means for notifying a message to the interface conversion device on the basis of an RS232C serial interface signal when a trouble is detected.

10. The maintenance service system according to claim 3, wherein
said incidental equipment has means for notifying the interface conversion device on the basis of a contact point signal with which a contact point is closed at a trouble occurrence time and opened at a normal time.

11. The maintenance service system according to any one of claims 5, 7, 8, 9 and 10, wherein
said interface conversion device has means for sensing the signal and carrying out trouble message conversion/addition corresponding to the signal.

12. The maintenance service system according to claim 1, further comprising
a system manager device containing a system console, an operation monitoring server and a mail server to manage the multi-vendor system at a system manager.

13. The maintenance service system according to claim 12, wherein
said system console and said operation monitoring server have means for detecting a message containing a trouble term from messages received by the system console and the operation monitoring server and transmitting the message thus detected to the primary maintainer terminal.

14. A maintenance service method for carrying out maintenance service method for a multi-vendor system which is constructed by various types of equipments supplied from plural vendors and carries out information processing, said method comprising the steps of:
at a multi-vendor system monitoring and reporting server,
monitoring said multi-vendor system to detect a trouble,
reporting trouble information to a primary maintainer terminal and a maintenance company system;
at said primary maintainer terminal,
receiving the trouble information reported from the multi-vendor system monitoring and reporting server,
carrying out trouble analysis and trouble dealing,
instructing a trouble solving dealing to a maintenance company system associated with the trouble,
creating a report document on trouble occurrence condition to transmit the report document to a system manager device, an end user client and a maintenance company system;
at said maintenance company system,
receiving the trouble information reported from said multi-vendor system monitoring and reporting server,
receiving the instruction of the trouble solving dealing from said primary maintainer terminal,
carrying out maintenance of equipments under trouble which constitutes said multi-vendor system,
reporting a trouble dealing condition to the primary maintainer terminal; and
at said primary maintainer terminal,
creating a report document on the trouble solving condition to transmit the report document to the system manager device, the end user client and the maintenance company.

15. The maintenance service method according to claim 14, further comprising the steps of
at a primary maintainer operating said primary maintainer terminal,
creating operation stop information for periodic checkup, current status information of each equipment, system operation relating information, report information relating to system management and process information for check and maintenance/repair work, and
transmitting an electronic mail having the information thus created via the multi-vendor system monitoring and reporting server or presenting the information thus created on the Web of the multi-vendor system monitoring and reporting server.

16. The maintenance service method according to claim 14, further comprising the steps of
at a primary maintainer,
starting and executing a test run job after the step of carrying out trouble dealing is completed,
checking whether the trouble is finished, and
restarting a business operation.

17. The maintenance service method according to claim 14, wherein
the step of carrying out trouble dealing is entirely carried out by operation of a primary maintainer.

18. The maintenance service method according to claim 14, wherein
the step of carrying out trouble dealing is carried out with initiative by a primary maintainer grasping the whole of said multi-vendor system while the burden of said step of carrying out trouble dealing is shared to the primary maintainer and secondary and subsequent maintainers.

19. The maintenance service method according to claim 14, wherein
the step of carrying out trouble dealing comprises
a window dealing step at which the primary maintainer carries out a window dealing work to the system manager and the end user, wherein the primary maintainer delivers the trouble dealing work to the secondary and subsequent maintainers and the trouble dealing work thus delivered is carried out by the secondary and subsequent maintainers.

20. The maintenance service method according to claim 17, wherein
the step of carrying out trouble dealing comprises the steps of:
at said primary maintainer,
carrying out a restart-up operation when it is judged on the basis of a business content of a system server equipment under trouble and a trouble content that the system operation should be preferentially continued;
regarding the trouble occurrence as an intermittent trouble and continuing the system operation when the restart-up operation succeeds and thus the system operation is continued;
securing a machine time for investigation of causes for the trouble and research and countermeasure to trouble/failure;
stopping the operation when an operation stopping condition is satisfied;
regarding the trouble as not the intermittent trouble, but a fixed trouble and carrying out an operation stopping operation for carrying out a trouble dealing work;
stopping the system server equipment to preferentially investigate causes for the trouble occurrence and deal with the trouble when it is judged on the basis of the business content of a system server equipment under trouble and the trouble content that it is not preferential to continue the system operation;
collecting trouble error logs;
analyzing the error logs by an engineer of an assigned technical support department or the primary maintainer itself;
ordering a trouble part when a trouble site is found out through the error log analysis;
settling a part estimated as a cause of the trouble on the basis of the trouble content and the error logs when no trouble site is found out, and ordering the part thus settled;
receiving a part delivered;
exchanging the trouble part or trouble-estimated part by the part thus delivered; and
reporting a trouble-dealing information on the trouble dealing condition and the prospect of recovery to the system manager and the end user.

21. The maintenance service method according to claim 18, wherein
the step of carrying out trouble dealing comprises the steps of:
at said primary maintainer,
carrying out a restart-up operation, an operation stopping operation, an operation of stopping securing investigation machine time and an error-log collecting operation, the operations being relevant to the operation of system server equipment;
at said secondary and subsequent maintainers,
analyzing the error logs,
specifying a trouble part, ordering a new part, carrying the new part,
exchanging the trouble part by the new part,
reporting a trouble dealing condition to the primary maintainer; and
at said primary maintainer,
receiving a progress report from the secondary and subsequent maintainers,
reporting trouble dealing information on the trouble dealing condition and the prospect of recovery to the system manager and the end user together with a primary-maintainer's estimate of the situation.

22. The maintenance service method according to claim 19, wherein
the step of carrying out trouble dealing comprises the steps of:
at said secondary and subsequent maintainers,
re-starting up,
stopping the operation,
collecting error logs,
analyzing the error logs,
specifying a trouble part,
ordering the part,
carrying the part,
exchanging the part,
reporting the trouble dealing condition to the primary maintainer by the secondary and subsequent maintainers; and
at said primary maintainer,
receiving a progress repot from the secondary and subsequent maintainers,
reporting trouble dealing information on the trouble dealing condition and the prospect of recovery to the system manager and the end user together with a primary-maintainer's estimate of the situation.

23. The maintenance service method according to any one of claims 20, 21, and 22, wherein
the step of carrying out trouble dealing further comprises the steps of:
with respect to software trouble,
collecting trouble dump data;
analyzing the dump data;
requesting creation of a patch correction object for the software trouble;
achieving the patch correction object thus requested; and
applying the patch correction object thus achieved.

24. A maintenance service program for enabling a computer to execute maintenance service method for a multi-vendor system which is constructed by various types of equipments supplied from plural vendors and carries out information processing, said method comprising the steps of:
at a multi-vendor system monitoring and reporting server,
monitoring the multi-vendor system to detect a trouble, and
reporting trouble information to a primary maintainer terminal and a maintenance company system;
at the primary maintainer terminal,
receiving the trouble information reported from the multi-vendor system monitoring and reporting server,
carrying out a trouble dealing work, a function of instructing a trouble solving work to a maintenance company system associated with the trouble, and
creating a report document on a trouble occurrence condition and a trouble solving condition and transmitting the report document to a system manager device, an end user client and the maintenance company system; and
at the maintenance company system,
receiving the trouble information reported from the multi-vendor system monitoring and reporting server,
receiving an instruction of the trouble solving work from the primary maintainer terminal,
carrying out maintenance for trouble equipment constituting the multi-vendor system and a function of reporting a trouble dealing condition to the primary maintainer terminal.

25. The maintenance service program according to claim 24, wherein said method further comprises the step of:
at the primary maintainer terminal,
creating operation stop information for periodic checkup, current status information of each equipment, system operation relating information, report information relating to system management and process information of maintenance/repair work;
transmitting the information thus created through the multi-vendor system monitoring and reporting server with an electronic mail; and
presenting the information thus created on the Web of the multi-vendor system monitoring and reporting server.
